(19) United States
(12) Patent Application Publication
(10) Pub. No.: US 2018/0232092 A1
(43) Pub. Date: Aug. 16, 2018

(54) TOUCH INPUT DEVICE

(71) Applicant: HiDeep Inc., Gyeonggi-do (KR)

(72) Inventors: Chi Woong Lee, Gyeonggi-do (KR); Seyeob Kim, Gyeonggi-do (KR); Bonkee Kim, Gyeonggi-do (KR)

(21) Appl. No.: 15/896,580

(22) Filed: Feb. 14, 2018

(30) Foreign Application Priority Data
Feb. 16, 2017 (KR) 1020170021239

(51) Int. Cl. G06F 3/041; G06F 3/044; G06F 21/31

(52) U.S. Cl. CPC G06F 3/0414; G06F 3/0412; G06F 2203/04112; G06F 21/31; G06F 3/044

(57) ABSTRACT

A touch input device may be provided that includes a cover layer including a display area and an input area; a display panel which is disposed under the display area; and a pressure sensing unit which is disposed under the display panel and is disposed at a position adjacent to the input area. The pressure sensing unit includes a pressure sensor. When a pressure is applied to the cover layer, the cover layer and the display panel are bent. Electrical characteristics of the pressure sensor change due to the bending of the cover layer and the display panel. When the pressure is applied to the input area, a magnitude of the pressure applied to the input area is detected by the electrical characteristics of the pressure sensor.

### CROSS REFERENCE TO RELATED APPLICATIONS

Priority is claimed under 35 U.S.C. § 119 to Korean Patent Application No. 10-2017-0021239, filed Feb. 16, 2017, the disclosure of which is incorporated herein by reference in its entirety.

### BACKGROUND

### Field

The present disclosure relates to a pressure sensing unit and a touch input device including the same, and more particularly to a touch input device capable of detecting a magnitude of a pressure which is applied to an input area of the touch input device, by using a pressure sensor which is disposed at a position adjacent to the input area.

### Description of the Related Art

Various kinds of input devices are being used to operate a computing system. For example, the input device includes a button, key, joystick and touch screen. Since the touch screen is easy and simple to operate, the touch screen is increasingly being used in operation of the computing system.

A touch surface of a touch input device such as the touch screen may be composed of a transparent panel including a touch-sensitive surface and of a touch sensor, i.e., a touch input means. The touch sensor is attached to the front side of a display screen, and then the touch-sensitive surface may cover the visible side of the display screen. The touch screen allows a user to operate the computing system by simply touching the touch screen by a finger, etc. Generally, the computing system recognizes the touch and a position of the touch on the touch screen and analyzes the touch, and thus, thereby performing the operations.

In such a touch input device, a corresponding input function according to the magnitude of a pressure is performed in an input area like a home key. For the purpose of such an input function, a separate physical pressure sensor should be provided, which increases the cost and there is a limit to reduce the size of the touch input device due to such a separate pressure sensor. Furthermore, when a pressure electrode using the capacitance change, instead of the physical pressure sensor, is disposed, there is a difficulty in detecting an appropriate pressure value by a circuit disposed under the corresponding input area, etc.

### BRIEF SUMMARY

One embodiment is a touch input device that includes: a cover layer including a display area and an input area; a display panel which is disposed under the display area; and a pressure sensing unit which is disposed under the display panel and is disposed at a position adjacent to the input area. The pressure sensing unit includes a pressure sensor. When a pressure is applied to the cover layer, the cover layer and the display panel are bent. Electrical characteristics of the pressure sensor change due to the bending of the cover layer and the display panel. When the pressure is applied to the input area, a magnitude of the pressure applied to the input area is detected by the electrical characteristics of the pressure sensor.

Another embodiment is a touch input device that includes: a cover layer including a display area and an input area; a display panel which is disposed under the display area; and a pressure sensing unit which is disposed under the display panel. The pressure sensing unit includes a plurality of pressure sensors. When a pressure is applied to the cover layer, the cover layer and the display panel are bent. Electrical characteristics of the plurality of pressure sensors change due to the bending of the cover layer and the display panel. When the pressure is applied to the display area, a magnitude of the pressure applied to the display area is detected by the electrical characteristics of the plurality of pressure sensors. When the pressure is applied to the input area, a magnitude of the pressure applied to the input area is detected by the electrical characteristics of the pressure sensor out of the plurality of pressure sensors, which is disposed at a position adjacent to the input area.

### BRIEF DESCRIPTION OF THE DRAWINGS

FIGS. 1a and 1b are schematic views showing a capacitance type touch sensor included in a touch input device and the configuration for the operation of the capacitance type touch sensor in accordance with an embodiment of the present invention;

FIG. 2 shows a control block for controlling a touch position, a touch pressure, and a display operation in the touch input device according to the embodiment of the present invention;

FIGS. 3a to 3b are conceptual views for describing the configuration of a display module in the touch input device according to the embodiment of the present invention;

FIG. 4a is a perspective view of the touch input device according to the embodiment of the present invention;

FIGS. 4b to 4e are plan views of the touch input device according to the embodiment of the present invention;

FIGS. 5a to 5h are views of the touch input device according to the embodiment of the present invention where a pressure sensing unit is disposed, as viewed from the bottom;

FIGS. 6a to 6e, 7a to 7j, and 8 are cross sectional views taken along line B-B′ of the touch input device according to the embodiment of the present invention shown in FIG. 4a;

FIGS. 9a and 9b are cross sectional views showing that a pressure is applied to the touch input device according to the embodiment of the present invention shown in FIGS. 5c and 8;

FIG. 9c is a cross sectional view showing that a pressure is applied to the touch input device according to the embodiment of the present invention shown in FIG. 5d;

FIGS. 10a and 10b are views showing the bending of a display panel when the pressure is applied to the touch input device according to the embodiment of the present invention shown in FIGS. 5c and 8;

FIGS. 11a, 11b, and 11d to 11g are cross sectional views taken along line A-A′ of the touch input device according to the embodiment of the present invention shown in FIG. 4a;

FIG. 11c is an exploded perspective view of the touch input device according to the embodiment of the present invention;

FIG. 12 shows a cross section of a sensor sheet according to the embodiment of the present invention;

FIGS. 13a to 13c are cross sectional views showing embodiments of pressure sensors formed directly on various display panels of the touch input device according to the embodiment of the present invention; and

FIGS. 14a to 14d are views showing a form of a sensor included in the touch input device according to the embodiment of the present invention.

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Similar reference numerals in the drawings designate the same or similar functions in many aspects.

Hereafter, a touch input device capable of detecting a pressure in accordance with an embodiment of the present invention will be described. Hereafter, while a capacitance type touch sensor 10 is exemplified below, the touch sensor 10 capable of detecting a touch position in any manner may be applied.

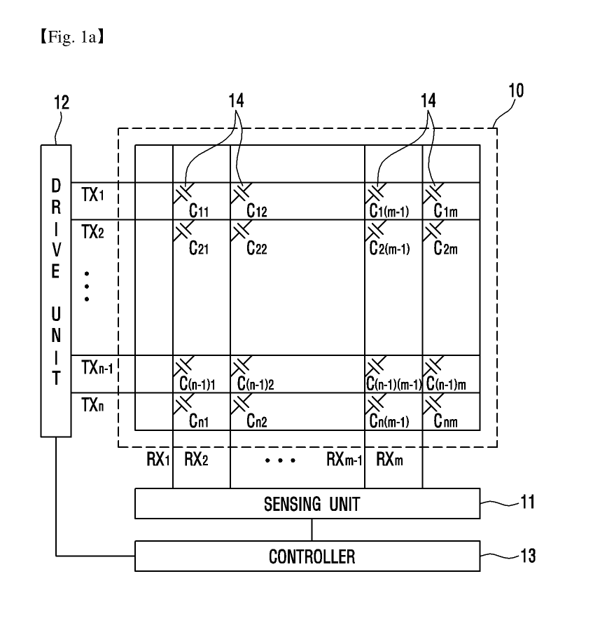

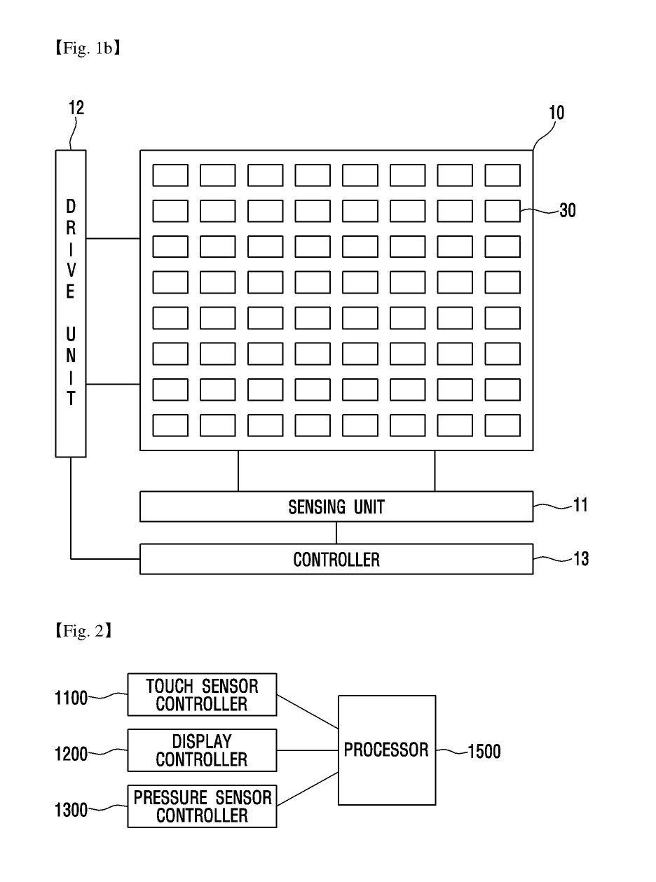

FIG. 1a is schematic views of a configuration of the capacitance type touch sensor 10 included in the touch input device according to the embodiment of the present invention and the operation of the capacitance type touch sensor. Referring to FIG. 1a, the touch sensor 10 may include a plurality of drive electrodes TX1 to TXn and a plurality of receiving electrodes RX1 to RXm, and may include a drive unit 12 which applies a drive signal to the plurality of the drive electrodes TX1 to TXn for the purpose of the operation of the touch sensor 10, and a sensing unit 11 which detects the touch and the touch position by receiving from the plurality of the receiving electrodes RX1 to RXm a sensing signal including information on a capacitance change amount changing according to the touch on a touch surface.

As shown in FIG. 1a, the touch sensor 10 may include the plurality of drive electrodes TX1 to TXn and the plurality of receiving electrodes RX1 to RXm. While FIG. 1a shows that the plurality of drive electrodes TX1 to TXn and the plurality of receiving electrodes RX1 to RXm of the touch sensor 10 form an orthogonal array, the present invention is not limited to this. The plurality of drive electrodes TX1 to TXn and the plurality of receiving electrodes RX1 to RXm has an array of arbitrary dimension, for example, a diagonal array, a concentric array, a 3-dimensional random array, etc., and an array obtained by the application of them. Here, “n” and “m” are positive integers and may be the same as each other or may have different values. The magnitude of the value may be changed depending on the embodiment.

The plurality of drive electrodes TX1 to TXn and the plurality of receiving electrodes RX1 to RXm may be arranged to cross each other. The drive electrode TX may include the plurality of drive electrodes TX1 to TXn extending in a first axial direction. The receiving electrode RX may include the plurality of receiving electrodes RX1 to RXm extending in a second axial direction crossing the first axial direction.

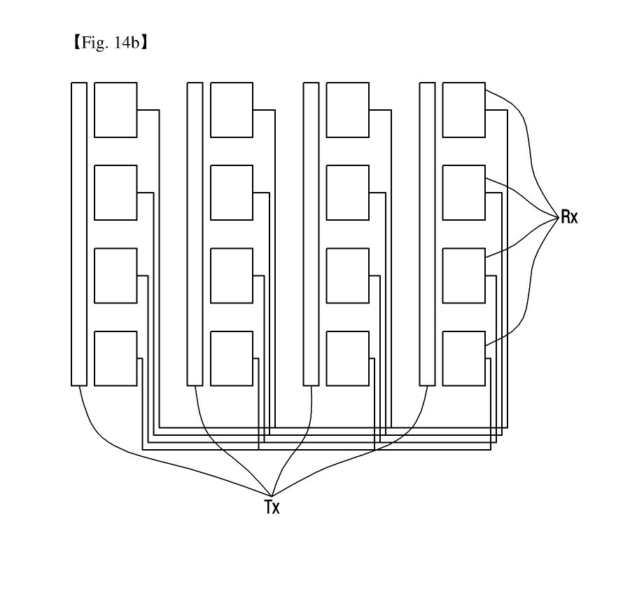

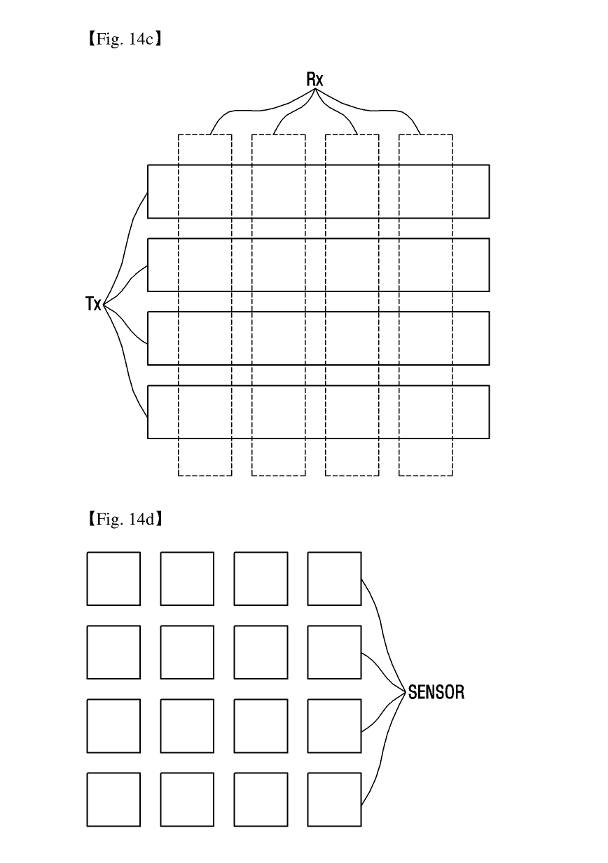

As shown in FIGS. 14a and 14b, in the touch sensor 10 according to the embodiment of the present invention, the plurality of drive electrodes TX1 to TXn and the plurality of receiving electrodes RX1 to RXm may be formed in the same layer. For example, the plurality of drive electrodes TX1 to TXn and the plurality of receiving electrodes RX1 to RXm may be formed on a top surface of a display panel 200A to be described later.

Also, as shown in FIG. 14c, the plurality of drive electrodes TX1 to TXn and the plurality of receiving electrodes RX1 to RXm may be formed in different layers. For example, any one of the plurality of drive electrodes TX1 to TXn and the plurality of receiving electrodes RX1 to RXm may be formed on the top surface of the display panel 200A, and the other may be formed on a bottom surface of a cover to be described later or may be formed within the display panel 200A.

The plurality of drive electrodes TX1 to TXn and the plurality of receiving electrodes RX1 to RXm may be made of a transparent conductive material (for example, indium tin oxide (ITO) or antimony tin oxide (ATO) which is made of tin oxide (SnO₂), and indium oxide (In₂O₃), etc.), or the like. However, this is only an example. The drive electrode TX and the receiving electrode RX may be also made of another transparent conductive material or an opaque conductive material. For instance, the drive electrode TX and the receiving electrode RX may include at least any one of silver ink, copper, and carbon nanotube (CNT). Also, the drive electrode TX and the receiving electrode RX may be made of metal mesh.

The drive unit 12 according to the embodiment of the present invention may apply a drive signal to the drive electrodes TX1 to TXn. In the embodiment of the present invention, one drive signal may be sequentially applied at a time to the first drive electrode TX1 to the n-th drive electrode TXn. The drive signal may be applied again repeatedly. This is only an example. The drive signal may be applied to the plurality of drive electrodes at the same time in accordance with the embodiment.

Through the receiving electrodes RX1 to RXm, the sensing unit 11 receives the sensing signal including information on a capacitance (Cm) 14 generated between the receiving electrodes RX1 to RXm and the drive electrodes TX1 to TXn to which the driving signal has been applied, thereby detecting whether or not the touch has occurred and where the touch has occurred. For example, the sensing signal may be a signal coupled by the capacitance (Cm) 14 generated between the receiving electrode RX and the drive electrode TX to which the driving signal has been applied. As such, the process of sensing the driving signal applied from the first drive electrode TX1 to the n-th drive electrode TXn through the receiving electrodes RX1 to RXm can be referred to as a process of scanning the touch sensor 10.

For example, the sensing unit 11 may include a receiver (not shown) which is connected to each of the receiving electrodes RX1 to RXm through a switch. The switch becomes the on-state in a time interval during which the signal of the corresponding receiving electrode RX is sensed, thereby allowing the receiver to sense the sensing signal from the receiving electrode RX. The receiver may include an amplifier (not shown) and a feedback capacitor coupled between the negative (−) input terminal of the amplifier and the output terminal of the amplifier, i.e., coupled to a feedback path. Here, the positive (+) input terminal of the amplifier may be connected to the ground. Also, the receiver may further include a reset switch which is connected in parallel with the feedback capacitor. The reset switch may reset the conversion from current to voltage that is performed by the receiver. The negative input terminal of the amplifier is connected to the corresponding receiving electrode RX and receives and integrates a current signal including information on the capacitance (Cm) 14, and then converts the integrated current signal into voltage. The sensing unit 11 may further include an analog to digital converter (ADC) (not shown) which converts the integrated data by the receiver into digital data. Later, the digital data may be input to a processor (not shown) and processed to obtain information on the touch on the touch sensor 10. The sensing unit 11 may include the ADC and processor as well as the receiver.

A controller 13 may perform a function of controlling the operations of the drive unit 12 and the sensing unit 11. For example, the controller 13 generates and transmits a drive control signal to the drive unit 12, so that the driving signal can be applied to a predetermined drive electrode TX1 at a predetermined time. Also, the controller 13 generates and transmits the drive control signal to the sensing unit 11, so that the sensing unit 11 may receive the sensing signal from the predetermined receiving electrode RX at a predetermined time and perform a predetermined function.

In FIG. 1a, the drive unit 12 and the sensing unit 11 may constitute a touch detection device (not shown) capable of detecting whether the touch has occurred on the touch sensor 10 or not and where the touch has occurred. The touch detection device may further include the controller 13. In the touch input device including the touch sensor 10, the touch detection device may be integrated and implemented on a touch sensing integrated circuit (IC) corresponding to a below-described touch sensor controller 1100. The drive electrode TX and the receiving electrode RX included in the touch sensor 10 may be connected to the drive unit 12 and the sensing unit 11 included in the touch sensing IC through, for example, a conductive trace and/or a conductive pattern printed on a circuit board, or the like. The touch sensing IC may be placed on a circuit board on which the conductive pattern has been printed, for example, a touch circuit board (hereafter, referred to as a touch PCB). According to the embodiment, the touch sensing IC may be mounted on a main board for operation of the touch input device.

As described above, a capacitance (Cm) with a predetermined value is generated at each crossing of the drive electrode TX and the receiving electrode RX. When an object like a finger approaches close to the touch sensor 10, the value of the capacitance may be changed. In FIG. 1a, the capacitance may represent a mutual capacitance (Cm). The sensing unit 11 senses such electrical characteristics, thereby being able to sense whether the touch has occurred on the touch sensor 10 or not and where the touch has occurred. For example, the sensing unit 11 is able to sense whether the touch has occurred on the surface of the touch sensor 10 comprised of a two-dimensional plane consisting of a first axis and a second axis.

More specifically, when the touch occurs on the touch sensor 10, the drive electrode TX to which the driving signal has been applied is detected, so that the position of the second axial direction of the touch can be detected. Likewise, when the touch occurs on the touch sensor 10, the capacitance change is detected from the reception signal received through the receiving electrode RX, so that the position of the first axial direction of the touch can be detected.

Up to now, although the operation mode of the touch sensor 10 sensing the touch position has been described on the basis of the mutual capacitance change amount between the drive electrode TX and the receiving electrode RX, the embodiment of the present invention is not limited to this. That is, as shown in FIG. 1b, it is also possible to detect the touch position on the basis of the change amount of a self-capacitance.

FIG. 1b is schematic views of a configuration of another capacitance type touch sensor 10 included in the touch input device according to another embodiment of the present invention and the operation of the capacitance type touch sensor. A plurality of touch electrodes 30 are provided on the touch sensor 10 shown in FIG. 1b. Although the plurality of touch electrodes 30 may be, as shown in FIG. 14d, disposed at a regular interval in the form of a grid, the present invention is not limited to this.

The drive control signal generated by the controller 13 is transmitted to the drive unit 12. On the basis of the drive control signal, the drive unit 12 applies the drive signal to the predetermined touch electrode 30 during a predetermined time period. Also, the drive control signal generated by the controller 13 is transmitted to the sensing unit 11. On the basis of the drive control signal, the sensing unit 11 receives the sensing signal from the predetermined touch electrode 30 during a predetermined time period. Here, the sensing signal may be a signal for the change amount of the self-capacitance formed on the touch electrode 30.

Here, whether the touch has occurred on the touch sensor 10 or not and/or the touch position are detected by the sensing signal detected by the sensing unit 11. For example, since the coordinate of the touch electrode 30 has been known in advance, whether the touch of the object on the surface of the touch sensor 10 has occurred or not and/or the touch position can be detected.

In the foregoing, for convenience of description, it has been described that the drive unit 12 and the sensing unit 11 operate individually as a separate block. However, the operation to apply the drive signal to the touch electrode 30 and to receive the sensing signal from the touch electrode 30 can be also performed by one drive and sensing unit.

The foregoing has described in detail the capacitance type touch sensor as the touch sensor 10. However, in the touch input device 1000 according to the embodiment of the present invention, the touch sensor 10 for detecting whether or not the touch has occurred and the touch position may be implemented by using not only the above-described method but also any touch sensing method such as a surface capacitance type method, a projected capacitance type method, a resistance film method, a surface acoustic wave (SAW) method, an infrared method, an optical imaging method, a dispersive signal technology, and an acoustic pulse recognition method, etc.

FIG. 2 shows a control block for controlling the touch position, a touch pressure and a display operation in the touch input device according to the embodiment of the present invention. In the touch input device 1000 configured to detect the touch pressure in addition to the display function and touch position detection, the control block may include the above-described touch sensor controller 1100 for detecting the touch position, a display controller 1200 for driving the display panel, and a pressure sensor controller 1300 for detecting the pressure. The display controller 1200 may include a control circuit which receives an input from an application processor (AP) or a central processing unit (CPU) on a main board for the operation of the touch input device 1000 and displays the contents that the user wants on the display panel 200A. The control circuit may be mounted on a display circuit board (hereafter, referred to as a display PCB). The control circuit may include a display panel control IC, a graphic controller IC, and a circuit required to operate other display panel 200A.

The pressure sensor controller 1300 for detecting the pressure through a pressure sensing unit may be configured similarly to the touch sensor controller 1100, and thus, may operate similarly to the touch sensor controller 1100. Specifically, as shown in FIGS. 1a and 1b, the pressure sensor controller 1300 may include the drive unit, the sensing unit, and the controller, and may detect a magnitude of the pressure by the sensing signal sensed by the sensing unit. Here, the pressure sensor controller 1300 may be mounted on the touch PCB on which the touch sensor controller 1100 has been mounted or may be mounted on the display PCB on which the display controller 1200 has been mounted.

According to the embodiment, the touch sensor controller 1100, the display controller 1200, and the pressure sensor controller 1300 may be included as different components in the touch input device 1000. For example, the touch sensor controller 1100, the display controller 1200, and the pressure sensor controller 1300 may be composed of different chips respectively. Here, a processor 1500 of the touch input device 1000 may function as a host processor for the touch sensor controller 1100, the display controller 1200, and the pressure sensor controller 1300.

The touch input device 1000 according to the embodiment of the present invention may include an electronic device including a display screen and/or a touch screen, such as a cell phone, a personal data assistant (PDA), a smartphone, a tablet personal computer (PC).

In order to manufacture such a thin and lightweight light-weighing touch input device 1000, the touch sensor controller 1100, the display controller 1200, and the pressure sensor controller 1300, which are, as described above, formed separately from each other, may be integrated into one or more configurations in accordance with the embodiment of the present invention. In addition to this, these controllers can be integrated into the processor 1500 respectively. Also, according to the embodiment of the present invention, the touch sensor 10 and/or the pressure sensing unit may be integrated into the display panel 200A.

In the touch input device 1000 according to the embodiment of the present invention, the touch sensor 10 for detecting the touch position may be positioned outside or inside the display panel 200A. The display panel 200A of the touch input device 1000 according to the embodiment of the present invention may be a display panel included in a liquid crystal display (LCD), a plasma display panel (PDP), an organic light emitting diode (OLED), etc. Accordingly, a user may perform the input operation by touching the touch surface while visually identifying an image displayed on the display panel.

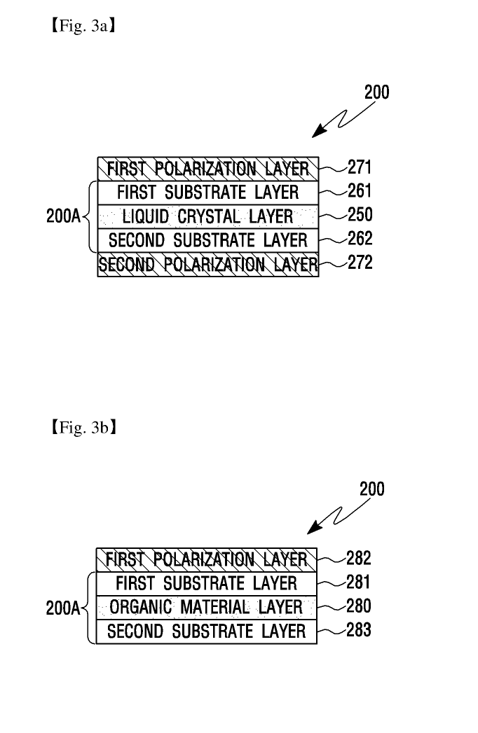

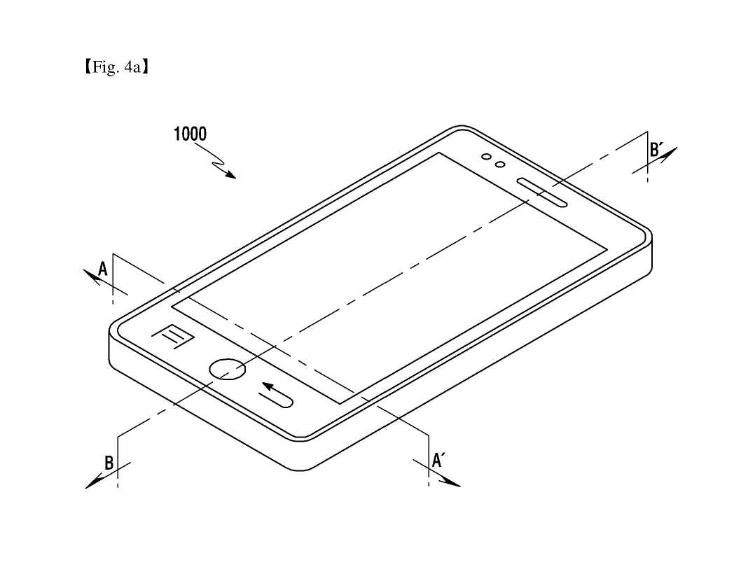

FIGS. 3a and 3b are conceptual views for describing a configuration of a display module 200 in the touch input device 1000 according to the embodiment of the present invention. First, the configuration of the display module 200 including the display panel 200A using an LCD panel will be described with reference to FIG. 3a.

As shown in FIG. 3a, the display module 200 may include the display panel 200A that is an LCD panel, a first polarization layer 271 disposed on the display panel 200A, and a second polarization layer 272 disposed under the display panel 200A. The display panel 200A that is an LCD panel may include a liquid crystal layer 250 including a liquid crystal cell, a first substrate layer 261 disposed on the liquid crystal layer 250, and a second substrate layer 262 disposed under the liquid crystal layer 250. Here, the first substrate layer 261 may be made of color filter glass, and the second substrate layer 262 may be made of TFT glass. Also, according to the embodiment, at least one of the first substrate layer 261 and the second substrate layer 262 may be made of a bendable material such as plastic. In FIG. 3a, the second substrate layer 262 may be comprised of various layers including a data line, a gate line, TFT, a common electrode, and a pixel electrode, etc. These electrical components may operate in such a manner as to generate a controlled electric field and orient liquid crystals located in the liquid crystal layer 250.

Next, the configuration of the display module 200 including the display panel 200A using an OLED panel will be described with reference to FIG. 3b.

As shown in FIG. 3b, the display module 200 may include the display panel 200A that is an OLED panel, and a first polarization layer 282 disposed on the display panel 200A. The display panel 200A that is an OLED panel may include an organic material layer 280 including an organic light-emitting diode (OLED), a first substrate layer 281 disposed on the organic material layer 280, and a second substrate layer 283 disposed under the organic material layer 280. Here, the first substrate layer 281 may be made of encapsulation glass, and the second substrate layer 283 may be made of TFT glass. Also, according to the embodiment, at least one of the first substrate layer 281 and the second substrate layer 283 may be made of a bendable material such as plastic. The OLED panel shown in FIG. 3b may include an electrode used to drive the display panel 200A, such as a gate line, a data line, a first power line (ELVDD), a second power line (ELVSS), etc. The organic light-emitting diode (OLED) panel is a self-light emitting display panel which uses a principle where, when current flows through a fluorescent or phosphorescent organic thin film and then electrons and electron holes are combined in the organic material layer, so that light is generated. The organic material constituting the light emitting layer determines the color of the light.

Specifically, the OLED uses a principle in which when electricity flows and an organic matter is applied on glass or plastic, the organic matter emits light. That is, the principle is that electron holes and electrons are injected into the anode and cathode of the organic matter respectively and are recombined in the light emitting layer, so that a high energy exciton is generated and the exciton releases the energy while falling down to a low energy state and then light with a particular wavelength is generated. Here, the color of the light is changed according to the organic matter of the light emitting layer.

The OLED includes a line-driven passive-matrix organic light-emitting diode (PM-OLED) and an individual driven active-matrix organic light-emitting diode (AM-OLED) in accordance with the operating characteristics of a pixel constituting a pixel matrix. None of them require a backlight. Therefore, the OLED enables a very thin display module to be implemented, has a constant contrast ratio according to an angle and obtains good color reproductivity depending on a temperature. Also, it is very economical in that non-driven pixel does not consume power.

In terms of operation, the PM-OLED emits light only during a scanning time at a high current, and the AM-OLED maintains a light emitting state only during a frame time at a low current. Therefore, the AM-OLED has a resolution higher than that of the PM-OLED and is advantageous for driving a large area display panel and consumes low power. Also, a thin film transistor (TFT) is embedded in the AM-OLED, and thus, each component can be individually controlled, so that it is easy to implement a delicate screen.

Also, the organic material layer 280 may include a hole injection layer (HIL), a hole transport layer (HTL), an electron injection layer (EIL), an electron transport layer (ETL), and a light-emitting layer (EML).

Briefly describing each of the layers, HIL injects electron holes and is made of a material such as CuPc, etc. HTL functions to move the injected electron holes and mainly is made of a material having a good hole mobility. The HTL may be made of Arylamine, TPD, and the like. The EIL and ETL inject and transport electrons. The injected electrons and electron holes are combined in the EML and emit light. The EML represents the color of the emitted light and is composed of a host determining the lifespan of the organic matter and an impurity (dopant) determining the color sense and efficiency. This just describes the basic structure of the organic material layer 280 include in the OLED panel. The present invention is not limited to the layer structure or material, etc., of the organic material layer 280.

The organic material layer 280 is inserted between an anode (not shown) and a cathode (not shown). When the TFT becomes an on-state, a driving current is applied to the anode and the electron holes are injected, and the electrons are injected to the cathode. Then, the electron holes and electrons move to the organic material layer 280 and emit the light.

It will be apparent to a skilled person in the art that the LCD panel or the OLED panel may further include other structures so as to perform the display function and may be deformed.

The display module 200 of the touch input device 1000 according to the embodiment of the present invention may include the display panel 200A and a configuration for driving the display panel 200A. Specifically, when the display panel 200A is an LCD panel, the display module 200 may include a backlight unit (not shown) disposed under the second polarization layer 272 and may further include a display panel control IC for operation of the LCD panel, a graphic control IC, and other circuits.

In the touch input device 1000 according to the embodiment of the present invention, the touch sensor 10 for detecting the touch position may be positioned outside or inside the display module 200.

When the touch sensor 10 in the touch input device 1000 positioned outside the display module 200, the touch sensor panel may be disposed on the display module 200, and the touch sensor 10 may be included in the touch sensor panel. The touch surface of the touch input device 1000 may be the surface of the touch sensor panel.

When the touch sensor 10 in the touch input device 1000 positioned inside the display module 200, the touch sensor 10 may be configured to be positioned outside the display panel 200A. Specifically, the touch sensor 10 may be formed on the top surfaces of the first substrate layers 261 and 281. Here, the touch surface of the touch input device 1000 may be an outer surface of the display module 200 and may be the top surface or bottom surface in FIGS. 3 and 3b.

When the touch sensor 10 in the touch input device 1000 positioned inside the display module 200, at least a portion of the touch sensor 10 may be configured to be positioned inside the display panel 200A, and at least a portion of the remaining touch sensor 10 may be configured to be positioned outside the display panel 200A. For example, any one of the drive electrode TX and the receiving electrode RX, which constitute the touch sensor 10, may be configured to be positioned outside the display panel 200A, and the other may be configured to be positioned inside the display panel 200A. Specifically, any one of the drive electrode TX and the receiving electrode RX, which constitute the touch sensor 10, may be formed on the top surface of the top surfaces of the first substrate layers 261 and 281, and the other may be formed on the bottom surfaces of the first substrate layers 261 and 281 or may be formed on the top surfaces of the second substrate layers 262 and 283.

When the touch sensor 10 in the touch input device 1000 positioned inside the display module 200, the touch sensor 10 may be configured to be positioned inside the display panel 200A. Specifically, the touch sensor 10 may be formed on the bottom surfaces of the first substrate layers 261 and 281 or may be formed on the top surfaces of the second substrate layers 262 and 283.

When the touch sensor 10 is positioned inside the display panel 200A, an electrode for operation of the touch sensor may be additionally disposed. However, various configurations and/or electrodes positioned inside the display panel 200A may be used as the touch sensor 10 for sensing the touch. Specifically, when the display panel 200A is the LCD panel, at least any one of the electrodes included in the touch sensor 10 may include at least any one of a data line, a gate line, TFT, a common electrode (Vcom), and a pixel electrode. When the display panel 200A is the OLED panel, at least any one of the electrodes included in the touch sensor 10 may include at least any one of a data line, a gate line, a first power line (ELVDD), and a second power line (ELVSS).

Here, the touch sensor 10 may function as the drive electrode and the receiving electrode described in FIG. 1a and may detect the touch position in accordance with the mutual capacitance between the drive electrode and the receiving electrode. Also, the touch sensor 10 may function as the single electrode 30 described in FIG. 1b and may detect the touch position in accordance with the self-capacitance of each of the single electrodes 30. Here, if the electrode included in the touch sensor 10 is used to drive the display panel 200A, the display panel 200A may be driven in a first time interval and the touch position may be detected in a second time interval different from the first time interval.

In the touch input device 1000 according to the embodiment of the present invention, by means of an adhesive like an optically clear adhesive (OCA), lamination may occur between a cover layer 100 on which the touch sensor for detecting the touch position has been formed and the display module 200 including the display panel 200A. As a result, the display color clarity, visibility and optical transmittance of the display module 200, which can be recognized through the touch surface of the touch sensor, can be improved.

Hereafter, a case where a sensor disposed at a position adjacent to an input area is used as the pressure sensing unit in order to detect the magnitude of the touch pressure which is applied to the input area in the touch input device according to the embodiment of the present invention is described in detail by way of an example.

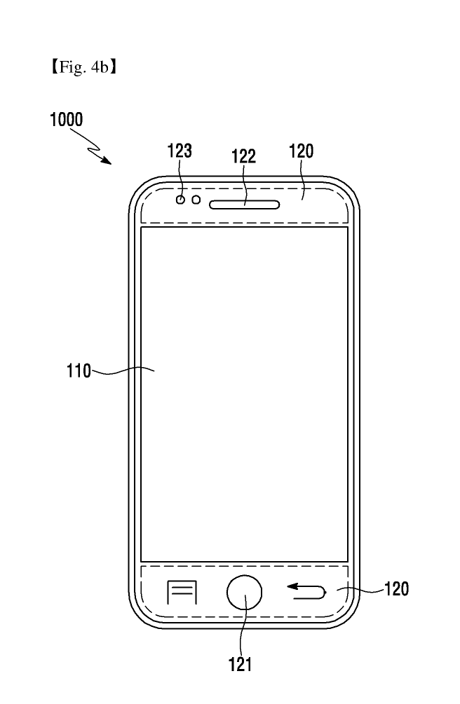

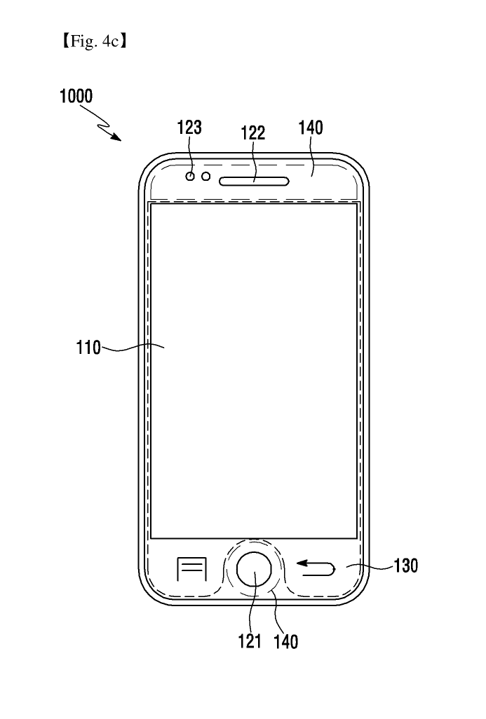

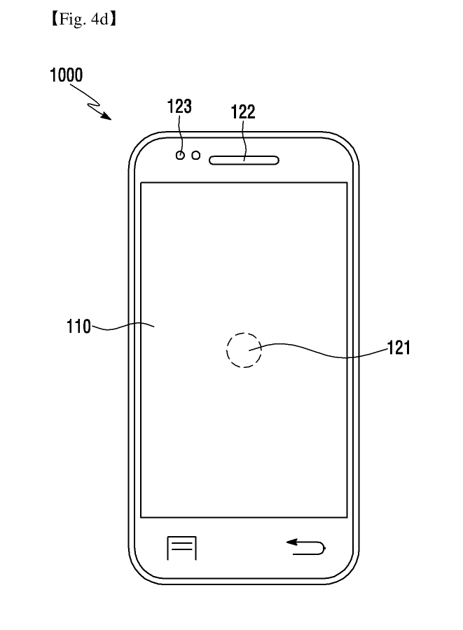

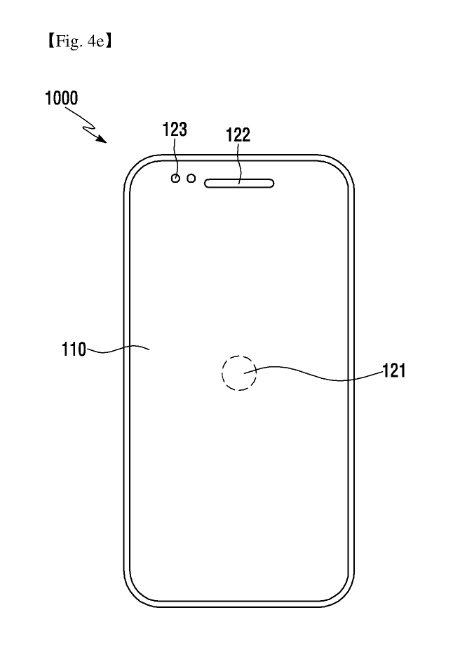

FIG. 4a is a perspective view of the touch input device according to the embodiment of the present invention. FIGS. 4b to 4e are plan views of the touch input device according to the embodiment of the present invention.

As shown in FIGS. 4b to 4e, the touch input device 1000 according to the embodiment of the present invention may include a display area 110 and an input area. Here, the input area may be a home key 121, a speaker 122, a camera 123, a backspace key, and a menu key, etc. Specifically, the cover layer 100 included in the touch input device 1000 may include the display area 110 and the input area. Also, the display panel 200A may be disposed under the display area 110 of the cover layer 100.

As shown in FIG. 4b, the touch input device 1000 according to the embodiment of the present invention may further include a non-display area 120. Specifically, the cover layer 100 included in the touch input device 1000 may include the display area 110 and the non-display area 120. Also, the display panel 200A may be disposed under the display area 110 of the cover layer 100, and the display panel 200A may not be disposed under the non-display area 120 of the cover layer 100. Here, the input area may be disposed within the non-display area 120.

As shown in FIG. 4c, the touch input device 1000 according to the embodiment of the present invention may include a touch position sensing area 130 and a non-touch position sensing area 140. Here, the touch position sensing area 130 may be the same as or not the same as the display area 110. Likewise, the non-touch position sensing area 140 may be the same as or not the same as the non-display area 120. Here, as shown in FIG. 4c, the touch position sensing area 130 may include the display area 110. Specifically, when the touch position sensing area 130 is the same as the display area 110, the touch sensor 10 for detecting the touch position may be disposed under the display area 110. Specifically, the touch sensor 10 may be integrally formed under the display area 110 of the cover layer 100 or may be included in the display panel 200 disposed under the display area 110. When the touch position sensing area 130 is not the same as the display area 110, the touch sensor 10 for detecting the touch position may be disposed under the non-display area 120 of the cover layer 100. Specifically, the touch sensor 10 may be integrally formed under the non-display area 120 of the cover layer 100.

As shown in FIG. 4d, the input area of the touch input device 1000 according to the embodiment of the present invention may be disposed within the display area 110. Also, as shown in FIG. 4e, the display area 110 may be disposed in the entire area of the touch input device 1000 according to the embodiment of the present invention. Specifically, the entire area of the cover layer 100 included in the touch input device 1000 may be the display area 110. Here, likewise, the input area of the touch input device 1000 according to the embodiment of the present invention may be disposed within the display area 110.

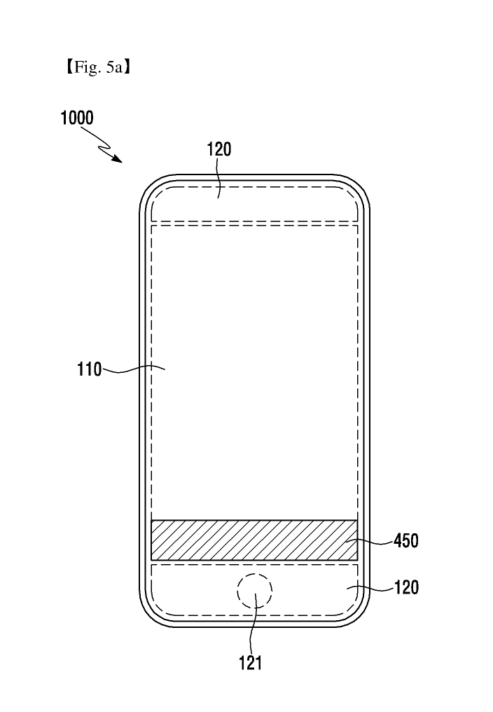

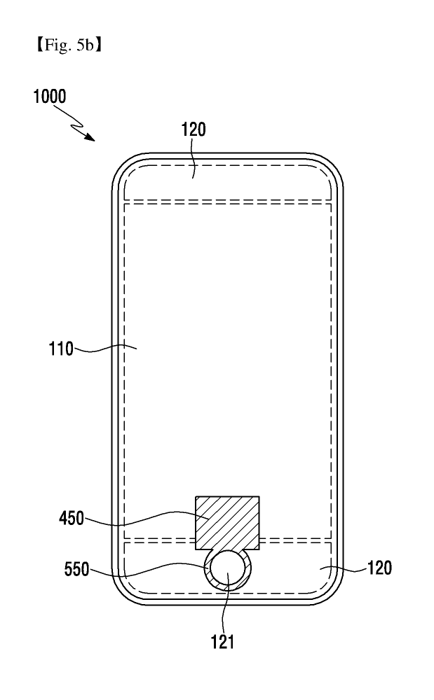

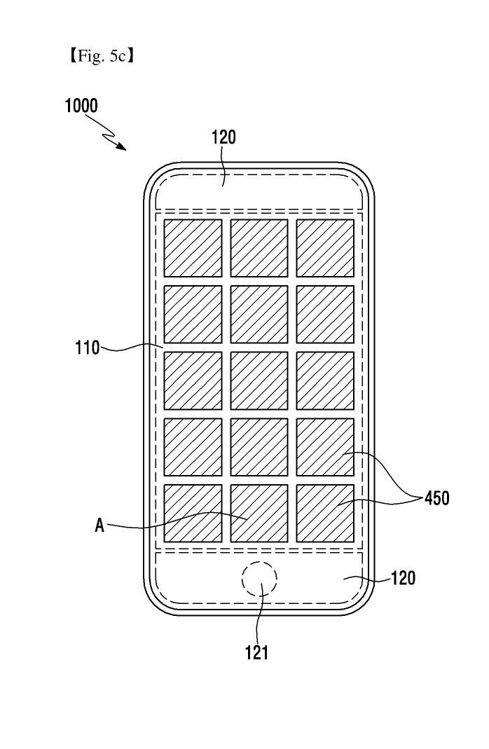

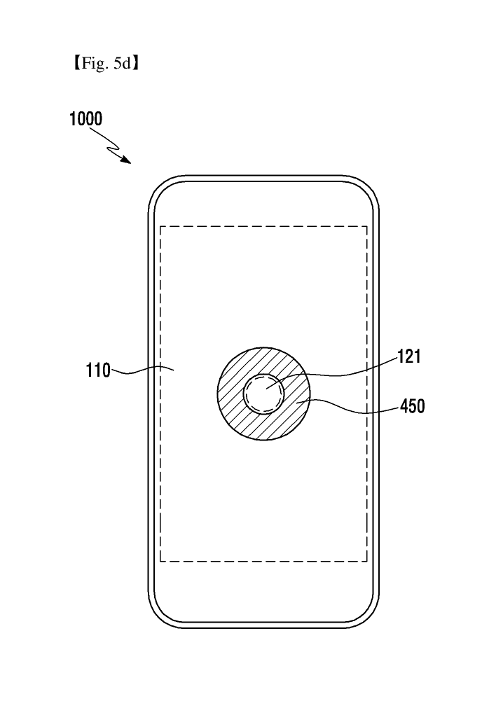

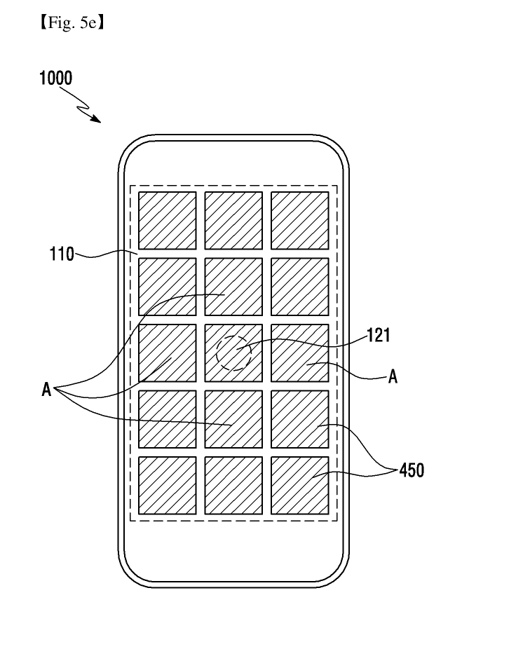

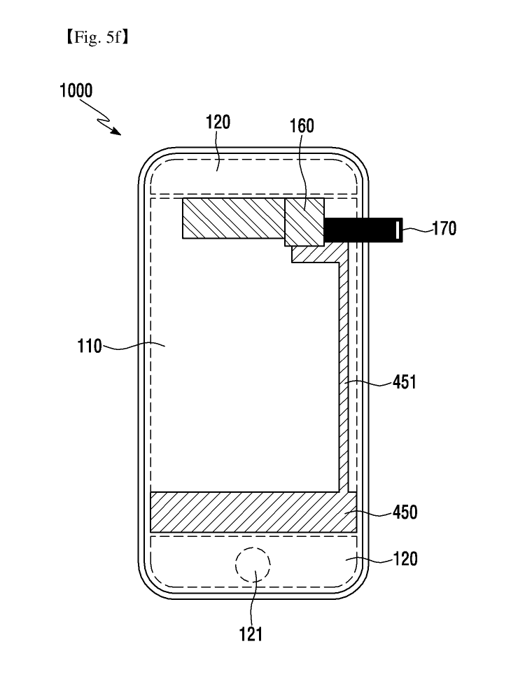

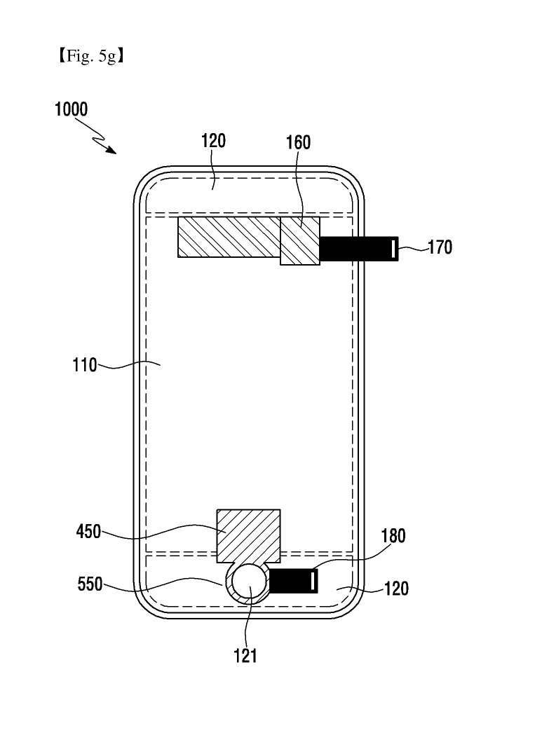

FIGS. 5a to 5h are views of the touch input device according to the embodiment of the present invention where a pressure sensing unit is disposed, as viewed from the bottom. Specifically, FIGS. 5a to 5h are bottom views showing the touch input device 1000 of which a substrate 300 and a housing 320 have been removed such that the pressure sensor 450 of the pressure sensing unit disposed under the display panel 200A of the touch input device 1000 according to the embodiment of the present invention can be seen.

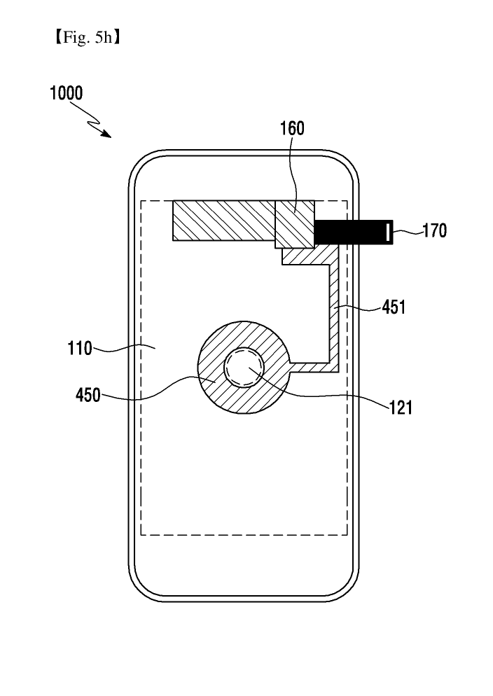

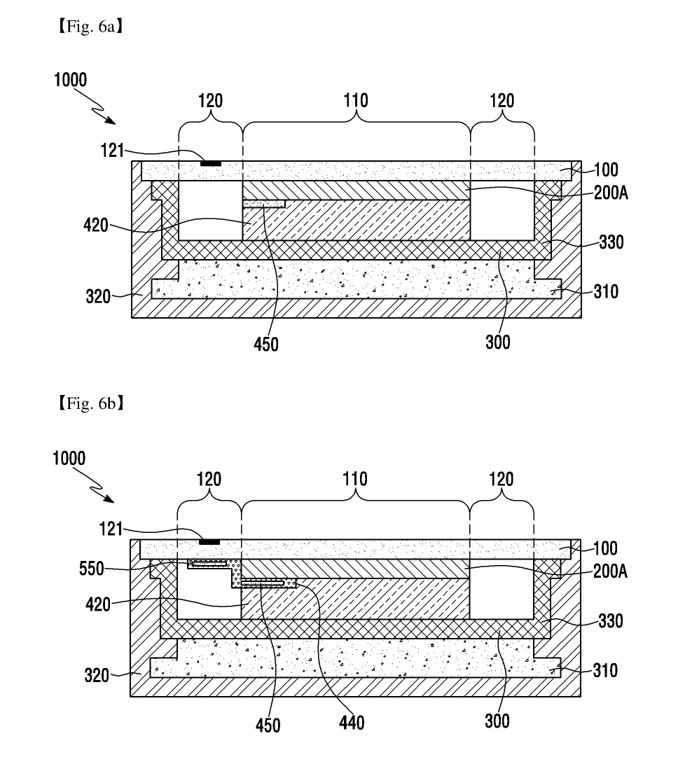

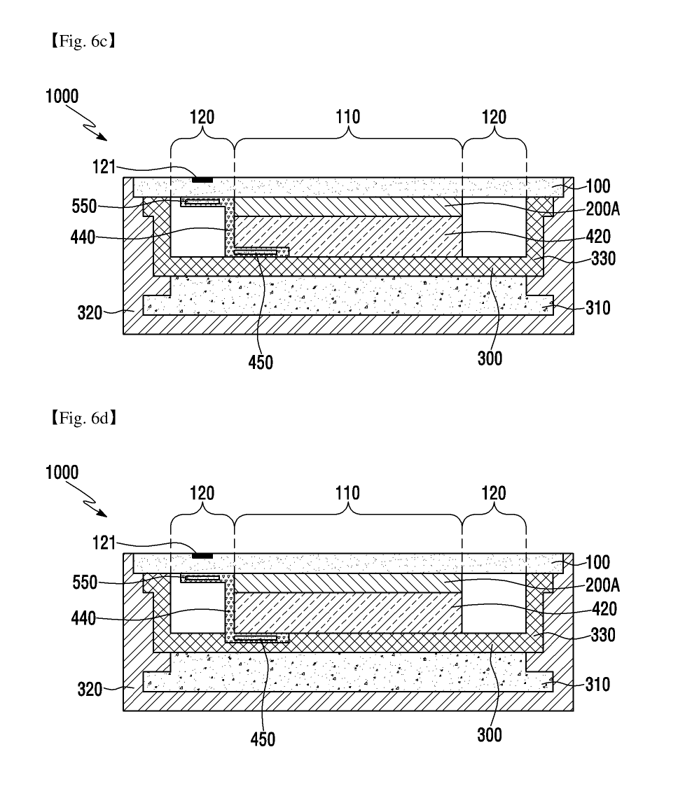

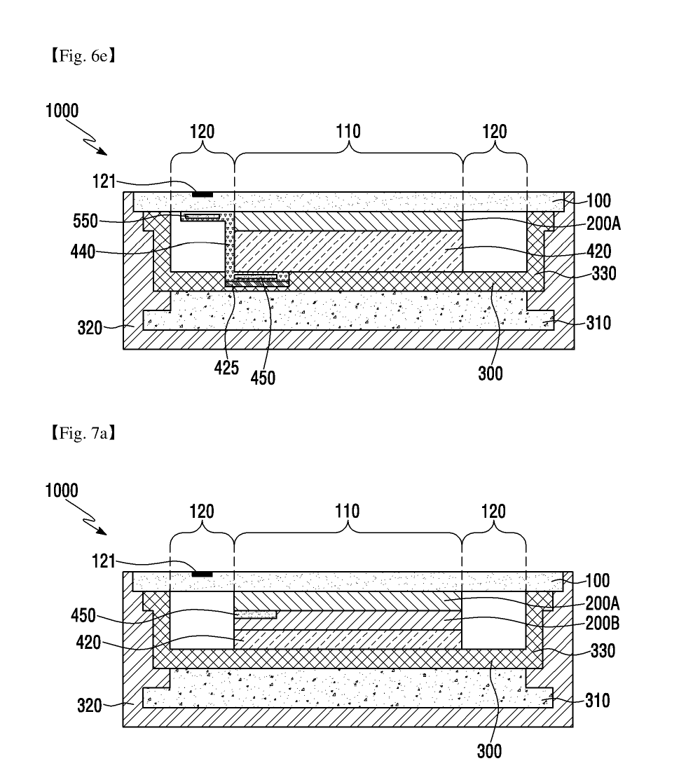

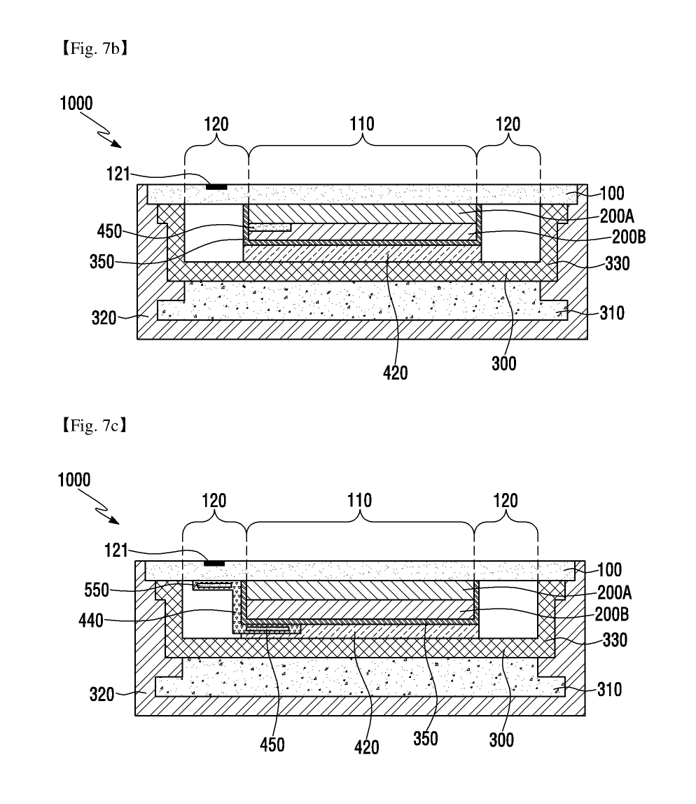

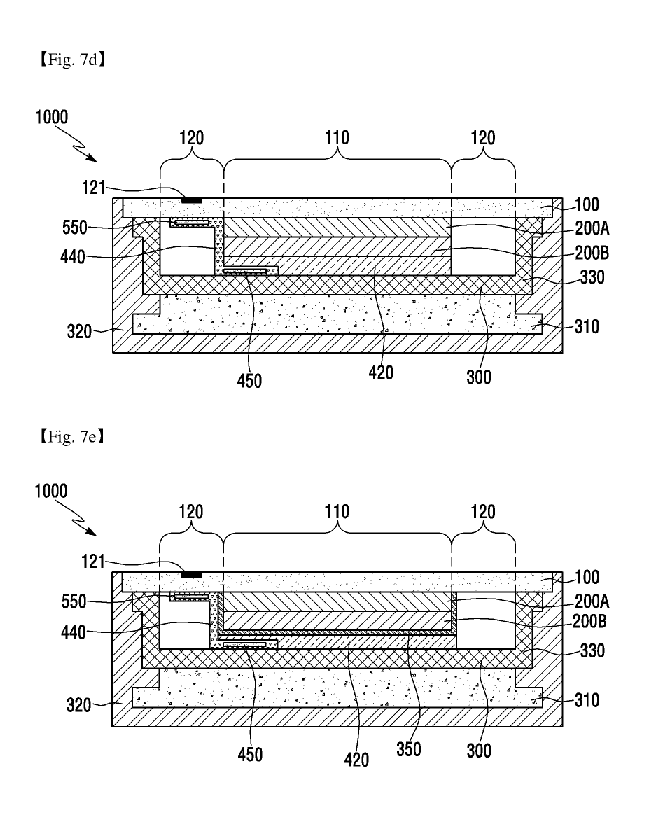

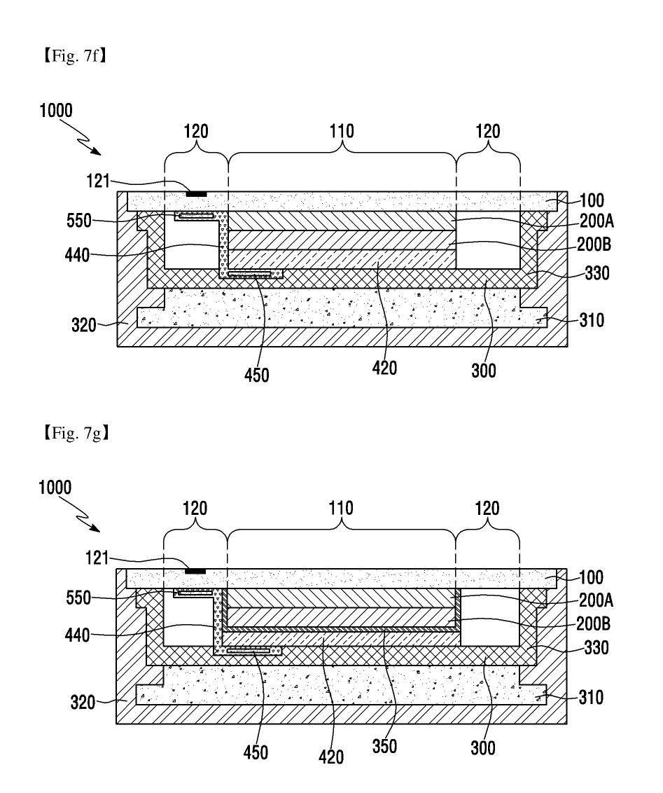

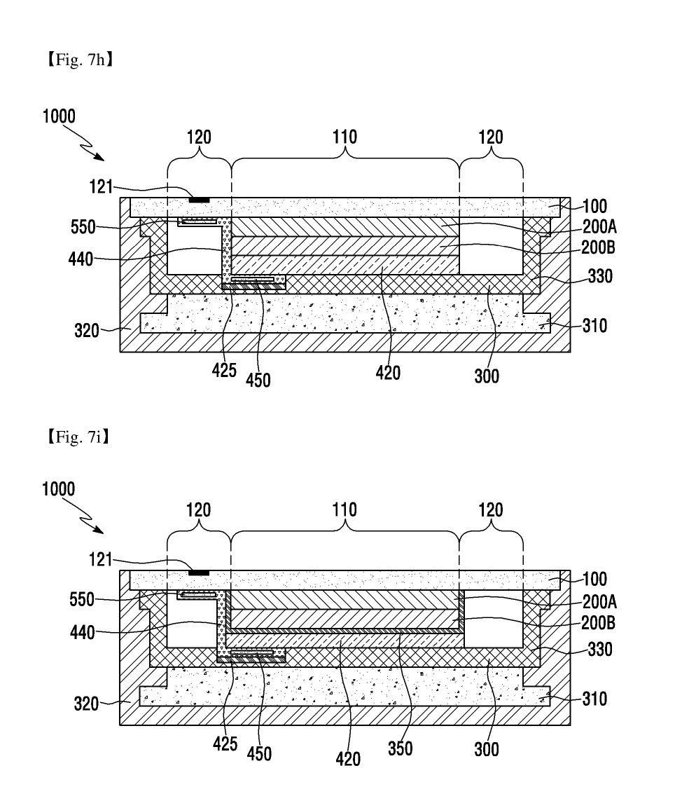

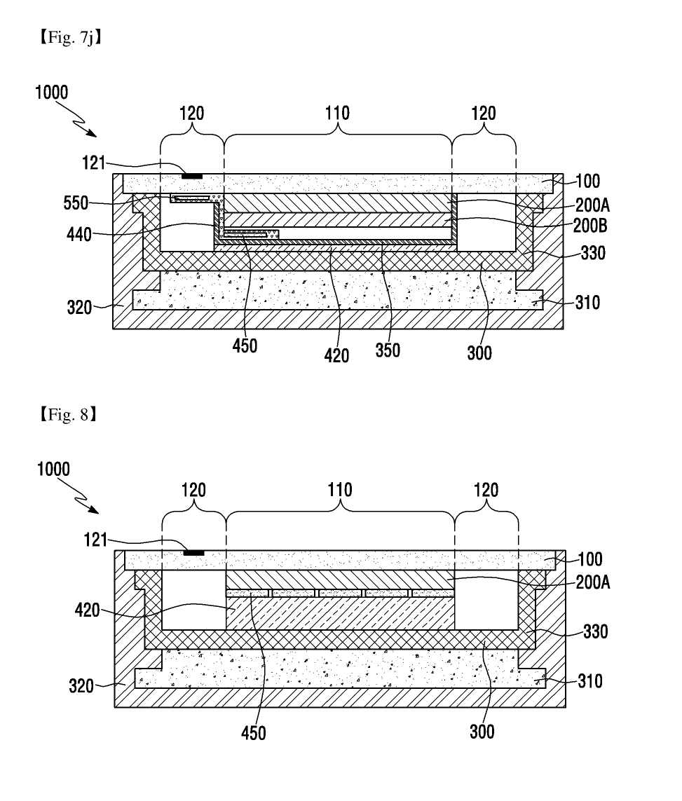

FIGS. 6a to 6e, 7a to 7j, and 8 are cross sectional views taken along line B-B′ of the touch input device according to the embodiment of the present invention shown in FIG. 4a. Specifically, FIGS. 6a to 6e are cross sectional views taken along line B-B′ of the touch input device shown in FIG. 4a according to the embodiment of the present invention to which the OLED panel as the display panel 200A has been applied. FIGS. 7a to 7j are cross sectional views taken along line B-B′ of the touch input device shown in FIG. 4a according to the embodiment of the present invention to which the LCD panel as the display panel 200A has been applied. FIG. 8 is a cross sectional view taken along line B-B′ of the touch input device shown in FIG. 4a where the pressure sensor shown in FIG. 5c has been provided.

As shown in FIGS. 5a, 6a, 7a, and 7b, the pressure sensing unit according to the embodiment of the present invention may be disposed in the display area 110. Specifically, the pressure sensor 450 included in the pressure sensing unit is disposed at a position in the display area 110, which is adjacent to the input area disposed within the non-display area 120, and may be disposed under the display panel 200A. Also, the pressure sensor 450 may be integrally formed on the bottom surface of the display panel 200A. Here, as shown in FIG. 5f, the pressure sensor 450 may be electrically connected to a first PCB 160 through a trace 451 extending from the pressure sensor 450. Also, as with the pressure sensor 450, the trace 451 may be formed directly on the bottom surface of the display panel 200A. Here, the first PCB 160 may be the touch PCB or the display PCB. Also, the pressure sensor 450 may be electrically connected to the main board through a first connecting portion 170 formed on the first PCB 160. Also, the touch input device 1000 according to the embodiment of the present invention may further include a separate touch sensor which detects whether or not the touch is input to the input area disposed within the non-display area 120. Specifically, the touch input device 1000 may further include a separate touch sensor (not shown) which detects whether or not the touch is input to the home key 121 shown in FIGS. 5a, 5f, 6a, and 7a. Here, the separate touch sensor (not shown) may be a sensor which simply detects whether the touch occurs or not or may be a user authentication sensor which has a function capable of authenticating the user, for example, a fingerprint sensor. In this case, the pressure sensor 450 may detect only the magnitude of the pressure applied to the input area disposed within the non-display area 120 without detecting the magnitude of the pressure applied to the display area 110 because the pressure sensor 450 is disposed only in a portion of the display area 110. As shown in FIG. 6a, when the OLED panel is applied as the display panel 200A, the pressure sensor 450 may be directly formed on the bottom surface of the second substrate layer 283, and the touch input device 1000 according to the embodiment of the present invention may include a spacer layer 420 disposed between the pressure sensor 450 and the substrate 300. As shown in FIGS. 7a and 7b, when the LCD panel is applied as the display panel 200A, the pressure sensor 450 may be directly formed on the bottom surface of the second substrate layer 262 or on the bottom surface of the second polarization layer 272, and the touch input device 1000 according to the embodiment of the present invention may include a backlight unit 200B disposed under the second polarization layer 272. Also, as shown in FIG. 7a, the touch input device 1000 according to the embodiment of the present invention may include the spacer layer 420 disposed between the backlight unit 200B and the substrate 300. As shown in FIG. 7b, the touch input device 1000 according to the embodiment of the present invention may include a SUS can 350 which is disposed under the backlight unit 200B and surrounds the display panel 200A and the backlight unit 200B and may include the spacer layer 420 disposed between the SUS can 350 and the substrate 300. Here, the SUS can 350 functions to protect the display panel 200A and the backlight unit 200B and may be fixed to the cover layer 100 or the display panel 200A.

As shown in FIGS. 5b, 6b, and 7c, the pressure sensing unit according to the embodiment of the present invention may be disposed in the display area 110 in the form of a sensor sheet 440. Specifically, the sensor sheet 440 including the pressure sensor 450 is disposed at a position in the display area 110, which is adjacent to the input area disposed within the non-display area 120, and may be attached under the display panel 200A. As shown in FIG. 6b, when the OLED panel is applied as the display panel 200A, the sensor sheet 440 may be attached to the bottom surface of the second substrate layer 283, and the touch input device 1000 according to the embodiment of the present invention may include the spacer layer 420 disposed between the sensor sheet 440 and the substrate 300. As shown in FIG. 7c, when the LCD panel is applied as the display panel 200A, the touch input device 1000 according to the embodiment of the present invention may include the backlight unit 200B disposed under the display panel 200A, the SUS can 350 disposed under the backlight unit 200B and having a bottom surface thereof to which the sensor sheet 440 is attached, and the spacer layer 420 disposed between the sensor sheet 440 and the substrate 300.

As shown in FIGS. 5b, 6c to 6e, and 7d to 7i, the pressure sensing unit according to the embodiment of the present invention may be disposed in the display area 110 in the form of the sensor sheet 440. Specifically, the sensor sheet 440 including the pressure sensor 450 is disposed at a position in the display area 110, which is adjacent to the input area disposed within the non-display area 120, and may be attached on the substrate 300. As shown in FIGS. 6c to 6e, when the OLED panel is applied as the display panel 200A, the touch input device 1000 according to the embodiment of the present invention may include the spacer layer 420 disposed between the sensor sheet 440 and the display panel 200A. As shown in FIGS. 7d to 7i, when the LCD panel is applied as the display panel 200A, the touch input device 1000 according to the embodiment of the present invention may include the backlight unit 200B disposed under the display panel 200A and may include the spacer layer 420 disposed between the backlight unit 200B and the sensor sheet 440. Here, as shown in FIGS. 7e, 7g, and 7i, the touch input device 1000 according to the embodiment of the present invention may further include the SUS can 350 disposed between the backlight unit 200B and the sensor sheet 440. Here, as shown in FIGS. 7f to 7i, a sensor groove 301 is formed in the substrate 300 of the touch input device 1000 according to the embodiment of the present invention, and at least a portion of the sensor sheet 440 may be inserted into the sensor groove 301. Here, the pressure sensor 450 may be disposed on a portion of the sensor sheet 440 which is inserted into the sensor groove 301. Here, in the state where the sensor sheet 440 is inserted into the sensor groove 301, the top surface of the sensor sheet 440 and the top surface of the region of the substrate 300 where the sensor groove 301 is not disposed may be disposed on the same plane. As such, when the top surface of the sensor sheet 440 and the top surface of the region of the substrate 300 where the sensor groove 301 is not disposed may be disposed on the same plane in the state where the sensor sheet 440 is inserted into the sensor groove 301, there is an advantage that the thickness of the region of the spacer layer 420, which is disposed on the sensor sheet 440 is the same as that of the region of the spacer layer 420 disposed on the region of the substrate 300, where the sensor sheet 440 is not disposed. Here, as shown in FIGS. 7f and 7g, the thickness of the sensor sheet 440 may be the same as the depth of the sensor groove 301. Also, as shown in FIGS. 7h and 7i, the touch input device 1000 according to the embodiment of the present invention may further include a groove spacer layer 425 which is inserted into the sensor groove 301 and is disposed under the sensor sheet 440 inserted into the sensor groove 301. In this case, a value obtained by the summation of the thickness of the sensor sheet 440 and the thickness of the groove spacer layer 425 may be the same as the depth of the sensor groove 301.

As shown in FIGS. 5b and 7j, the pressure sensing unit according to the embodiment of the present invention may be disposed in the display area 110 in the form of the sensor sheet 440. Specifically, as shown in FIG. 7j, when the LCD panel is applied as the display panel 200A, the touch input device 1000 according to the embodiment of the present invention may include the backlight unit 200B disposed under the display panel 200A, the SUS can 350 disposed under the backlight unit 200B, and the spacer layer 420 disposed between the SUS can 350 and the substrate 300. Here, the sensor sheet 440 may be spaced apart from the backlight unit 200B and disposed on the top surface of the SUS can 350. In this case, an additional spacer layer (not shown) may be disposed between the sensor sheet 440 and the backlight unit 200B.

Here, as shown in FIG. 5g, the pressure sensor 450 may be electrically connected to the main board through a second connecting portion 180 formed on the sensor sheet 440 including the pressure sensor 450. Also, the sensor sheet 440 may further include a separate touch sensor which detects whether or not the touch is input to the input area disposed within the non-display area 120. That is, the separate touch sensor may be disposed under the input area disposed within the non-display area 120 and may be integrally formed with the pressure sensing unit. Specifically, as shown in FIGS. 5b and 5g, the sensor sheet 440 may further include a separate touch sensor 550 which detects whether or not the touch is input to the home key 121. Here, the separate touch sensor 550 may be a sensor which simply detects whether the touch occurs or not or may be a user authentication sensor which has a function capable of authenticating the user, for example, a fingerprint sensor. In this case, the pressure sensor 450 may detect only the pressure applied to the input area disposed within the non-display area 120 without detecting the magnitude of the pressure applied to the display area 110 because the pressure sensor 450 is disposed only in a portion of the display area 110.

As shown in FIGS. 5c and 8, the pressure sensor 450 according to the embodiment of the present invention may be disposed in the display area 110. Specifically, the pressure sensor 450 may be disposed throughout the entire area of the display area 110. In this case, the pressure sensor 450 may detect the pressure which is applied to the display area 110 and may detect the pressure which is applied to the input area disposed within the non-display area 120 as well because the pressure sensor 450 may be disposed throughout the entire area of the display area 110. Specifically, as shown in FIGS. 5c and 8, the magnitude of the pressure which is applied to the display area 110 may be detected by using the plurality of pressure sensors 450, and the pressure which is applied to the input area disposed within the non-display area 120 may be detected by using the pressure sensor “A” among the pressure sensors 450, which is disposed at a position adjacent to the input area disposed within the non-display area 120. For example, the magnitude of the pressure which is applied to the home key 121 may be detected by using the pressure sensor “A” disposed at a position adjacent to the home key 121. Likewise, the touch input device 1000 may further include a separate touch sensor (not shown). The separate touch sensor may be a sensor which simply detects whether the touch occurs or not or may be a user authentication sensor which has a function capable of authenticating the user. Although it has been described in FIG. 8 that the pressures sensor 450 is directly formed on the bottom surface of the display panel 200A, there is no limitation to this. The pressure sensor 450 may be attached to the bottom surface of the display panel 200A in the form of a sensor sheet 440 or may be attached to the top surface of the substrate 300. Also, this can be also applied to a case where the display panel 200A is the LCD panel as well as the OLED panel.

The touch input device 1000 according to the embodiment of the present invention may determine whether the pressure is applied or not to the input area disposed within the non-display area 120 even without the separate touch sensor 550 disposed in the input area disposed within the non-display area 120. In the case where the touch position sensing area 130 is the same as the display area 110, the touch input device 1000 may determine that the pressure is applied to the input area disposed within the non-display area 120 when the touch position is not detected by the touch sensor 10 disposed under the display area 110. In the case where the touch position sensing area 130 is not the same as the display area 110, the touch input device 1000 may determine that the pressure is applied to the input area disposed within the non-display area 120 when the touch position is detected by the touch sensor 10 disposed under the input area disposed within the non-display area 120. As shown in FIG. 4c, in the case where the touch position sensing area 130 includes the display area 110, the touch input device 1000 may determine that the pressure is applied to the input area disposed within the non-display area 120 when the touch position is not detected by the touch sensor 10.

As shown in FIG. 5d, the pressure sensing unit according to the embodiment of the present invention may be disposed in the display area 110. Specifically, the pressure sensor 450 included in the pressure sensing unit is disposed at a position adjacent to the input area disposed within the in the display area 110, and may be disposed under the display panel 200A. Also, the pressure sensor 450 may be integrally formed on the bottom surface of the display panel 200A. Here, as shown in FIG. 5h, the pressure sensor 450 may be electrically connected to a first PCB 160 through a trace 451 extending from the pressure sensor 450. Also, as with the pressure sensor 450, the trace 451 may be formed directly on the bottom surface of the display panel 200A. Here, the first PCB 160 may be the touch PCB or the display PCB. Also, the pressure sensor 450 may be electrically connected to the main board through a first connecting portion 170 formed on the first PCB 160. Also, the touch input device 1000 according to the embodiment of the present invention may detect whether or not the touch is input to the input area disposed within the display area 110. Specifically, when the touch position is detected by the touch sensor 10 disposed under the input area disposed within the display area 110, the touch input device 1000 may determine that the pressure is applied to the input area disposed within the display area 110. The touch input device 1000 according to the embodiment of the present invention may further include a user authentication sensor which detects whether or not the touch is input to the input area and has a separate function capable of authenticating the user. Here, the user authentication sensor may be, for example, a fingerprint sensor. Even in this case, the pressure sensor 450 may be disposed in the form shown in FIGS. 6a to 6e and 7a to 7j. Specifically, as shown in FIG. 6a, when the OLED panel is applied as the display panel 200A, the pressure sensor 450 may be directly formed on the bottom surface of the second substrate layer 283, and the touch input device 1000 according to the embodiment of the present invention may include the spacer layer 420 disposed between the pressure sensor 450 and the substrate 300. As shown in FIGS. 7a and 7b, when the LCD panel is applied as the display panel 200A, the pressure sensor 450 may be directly formed on the bottom surface of the second substrate layer 262 or on the bottom surface of the second polarization layer 272, and the touch input device 1000 according to the embodiment of the present invention may include the backlight unit 200B disposed under the second polarization layer 272. Also, as shown in FIG. 7a, the touch input device 1000 according to the embodiment of the present invention may include the spacer layer 420 disposed between the backlight unit 200B and the substrate 300. As shown in FIG. 7b, the touch input device 1000 according to the embodiment of the present invention may include the SUS can 350 which is disposed under the backlight unit 200B and surrounds the display panel 200A and the backlight unit 200B and may include the spacer layer 420 disposed between the SUS can 350 and the substrate 300. Here, the SUS can 350 functions to protect the display panel 200A and the backlight unit 200B and may be fixed to the cover layer 100 or the display panel 200A.

Also, as shown in FIGS. 6b and 7c, the pressure sensing unit according to the embodiment of the present invention may be disposed in the display area 110 in the form of a sensor sheet 440. Specifically, the sensor sheet 440 including the pressure sensor 450 is disposed at a position in the display area 110, which is adjacent to the input area, for example, the home key 121, and may be attached under the display panel 200A. As shown in FIG. 6b, when the OLED panel is applied as the display panel 200A, the sensor sheet 440 may be attached to the bottom surface of the second substrate layer 283, and the touch input device 1000 according to the embodiment of the present invention may include the spacer layer 420 disposed between the sensor sheet 440 and the substrate 300. As shown in FIG. 7c, when the LCD panel is applied as the display panel 200A, the touch input device 1000 according to the embodiment of the present invention may include the backlight unit 200B disposed under the display panel 200A, the SUS can 350 disposed under the backlight unit 200B and having a bottom surface thereof to which the sensor sheet 440 is attached, and the spacer layer 420 disposed between the sensor sheet 440 and the substrate 300.

As shown in FIGS. 6c to 6e and 8d to 7i, the pressure sensing unit according to the embodiment of the present invention may be disposed in the display area 110 in the form of the sensor sheet 440. Specifically, the sensor sheet 440 including the pressure sensor 450 is disposed at a position in the display area 110, which is adjacent to the input area, for example, the home key 121, and may be attached on the substrate 300. As shown in FIGS. 6c to 6e, when the OLED panel is applied as the display panel 200A, the touch input device 1000 according to the embodiment of the present invention may include the spacer layer 420 disposed between the sensor sheet 440 and the display panel 200A. As shown in FIGS. 7d to 7i, when the LCD panel is applied as the display panel 200A, the touch input device 1000 according to the embodiment of the present invention may include the backlight unit 200B disposed under the display panel 200A and may include the spacer layer 420 disposed between the backlight unit 200B and the sensor sheet 440. Here, as shown in FIGS. 7e, 7g, and 7i, the touch input device 1000 according to the embodiment of the present invention may further include the SUS can 350 disposed between the backlight unit 200B and the sensor sheet 440. Here, as shown in FIGS. 7f to 7i, the sensor groove 301 is formed in the substrate 300 of the touch input device 1000 according to the embodiment of the present invention, and at least a portion of the sensor sheet 440 may be inserted into the sensor groove 301. Here, the pressure sensor 450 may be disposed on a portion of the sensor sheet 440 which is inserted into the sensor groove 301. Here, in the state where the sensor sheet 440 is inserted into the sensor groove 301, the top surface of the sensor sheet 440 and the top surface of the region of the substrate 300 where the sensor groove 301 is not disposed may be disposed on the same plane. As such, when the top surface of the sensor sheet 440 and the top surface of the region of the substrate 300 where the sensor groove 301 is not disposed may be disposed on the same plane in the state where the sensor sheet 440 is inserted into the sensor groove 301, there is an advantage that the thickness of the region of the spacer layer 420, which is disposed on the sensor sheet 440 is the same as that of the region of the spacer layer 420 disposed on the region of the substrate 300, where the sensor sheet 440 is not disposed. Here, as shown in FIGS. 7f and 7g, the thickness of the sensor sheet 440 may be the same as the depth of the sensor groove 301. Also, as shown in FIGS. 7h and 7i, the touch input device 1000 according to the embodiment of the present invention may further include the groove spacer layer 425 which is inserted into the sensor groove 301 and is disposed under the sensor sheet 440 inserted into the sensor groove 301. In this case, a value obtained by the summation of the thickness of the sensor sheet 440 and the thickness of the groove spacer layer 425 may be the same as the depth of the sensor groove 301.

As shown in FIG. 7j, the pressure sensing unit according to the embodiment of the present invention may be disposed in the display area 110 in the form of the sensor sheet 440. Specifically, as shown in FIG. 7j, when the LCD panel is applied as the display panel 200A, the touch input device 1000 according to the embodiment of the present invention may include the backlight unit 200B disposed under the display panel 200A, the SUS can 350 disposed under the backlight unit 200B, and the spacer layer 420 disposed between the SUS can 350 and the substrate 300. Here, the sensor sheet 440 may be spaced apart from the backlight unit 200B and disposed on the top surface of the SUS can 350. In this case, an additional spacer layer (not shown) may be disposed between the sensor sheet 440 and the backlight unit 200B.

As shown in FIG. 5e, the pressure sensor 450 according to the embodiment of the present invention may be disposed in the display area 110. Specifically, the pressure sensor 450 may be disposed throughout the entire area of the display area 110. In this case, the pressure sensor 450 may detect the pressure which is applied to the display area 110 and may detect the pressure which is applied to the input area as well. Specifically, as shown in FIG. 5e, the magnitude of the pressure which is applied to the display area 110 may be detected by using the plurality of pressure sensors 450, and the pressure which is applied to the input area may be detected by using the pressure sensor “A” among the pressure sensors 450, which is disposed at a position adjacent to the input area. For example, the magnitude of the pressure which is applied to the home key 121 may be detected by using the pressure sensor “A” disposed at a position adjacent to the home key 121. Likewise, the touch input device 1000 may further include a user authentication sensor which has a separate function capable of authenticating the user. Although it has been described in FIG. 8 that the pressures sensor 450 is directly formed on the bottom surface of the display panel 200A, there is no limitation to this. The pressure sensor 450 may be attached to the bottom surface of the display panel 200A in the form of a sensor sheet 440 or may be attached to the top surface of the substrate 300. Also, this can be also applied to a case where the display panel 200A is the LCD panel as well as the OLED panel.

The touch input device 1000 according to the embodiment of the present invention may determine whether the pressure is applied or not to the input area. The touch input device 1000 may determine that the pressure is applied to the input area when the touch position is detected by the touch sensor 10 disposed under the input area.

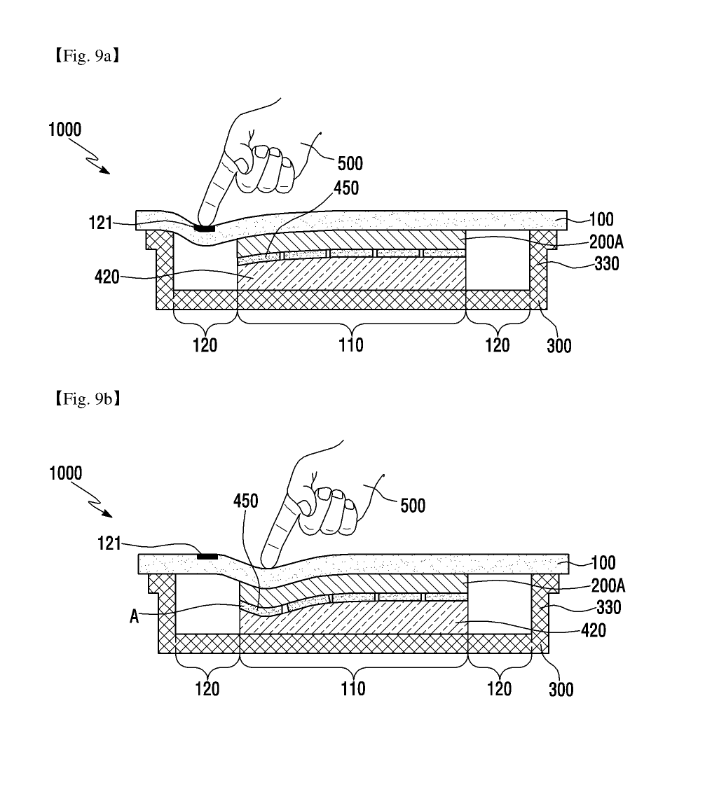

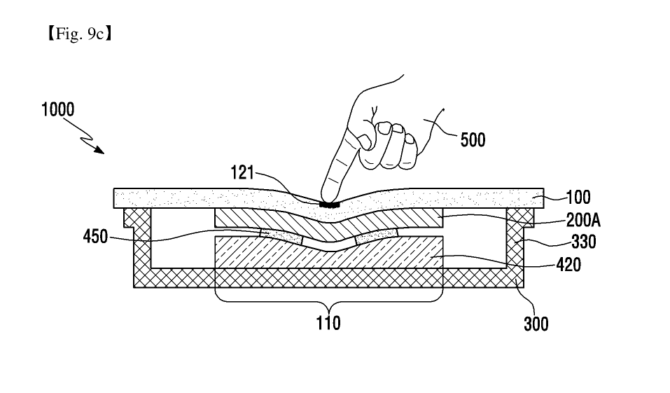

FIGS. 9a and 9b are cross sectional views showing that the pressure is applied to the touch input device according to the embodiment of the present invention shown in FIGS. 5c and 8. FIG. 9c is a cross sectional view showing that the pressure is applied to the touch input device according to the embodiment of the present invention shown in FIG. 5d. Specifically, FIG. 9a is a cross sectional view taken along line B-B′ of FIG. 4a when the pressure is applied to the input area disposed within the non-display area 120 of the touch input device 1000 shown in FIGS. 5c and 8. FIG. 9b is a cross sectional view taken along line B-B′ of FIG. 4a when the pressure is applied to the display area 110 of the touch input device 1000 shown in FIGS. 5c and 8. FIG. 9c is a cross sectional view taken along line B-B′ of FIG. 4a when the pressure is applied to the input area disposed within the display area 110 of the touch input device 1000 shown in FIG. 5d.

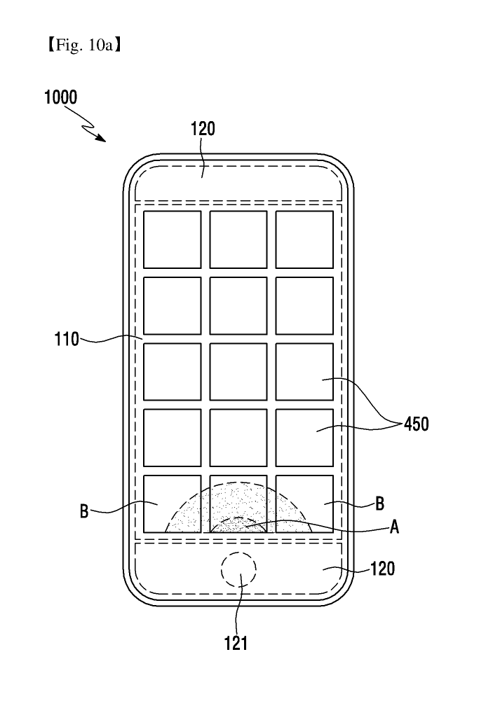

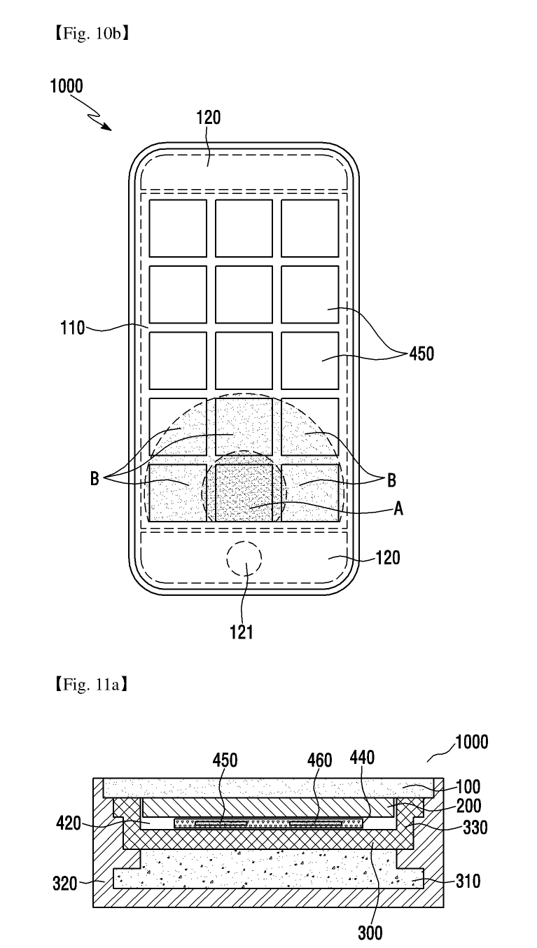

FIGS. 10a and 10b are views showing the bending of the display panel when the pressure is applied to the touch input device according to the embodiment of the present invention shown in FIGS. 5c and 8. Specifically, FIG. 10a is a view showing the bending of the display panel when the pressure is applied to the non-display area 120 of the touch input device 1000 shown in FIGS. 5c and 8. FIG. 10b is a view showing the bending of the display panel when the pressure is applied to the display area 110 of the touch input device 1000 shown in FIGS. 5c and 8.

As shown in FIGS. 9a to 9c, when the pressure is applied to the cover layer 100, the cover layer 100 and the display panel 200A may be bent. Here, due to the bending of the cover layer 100 and the display panel 200A, the electrical characteristics of the pressure sensor 450 disposed under the display panel 200A may change and the magnitude of the applied pressure may be detected by such a change of the electrical characteristics of the pressure sensor 450. Specifically, as shown in FIG. 9a, when the pressure is applied to the input area disposed within the non-display area 120, the magnitude of the pressure applied to the input area disposed within the non-display area 120 may be detected by the electrical characteristics of the pressure sensor “A” disposed at a position adjacent to the input area disposed within the non-display area 120. Also, as shown in FIG. 9c, when the pressure is applied to the input area disposed within the display area 110, the magnitude of the pressure applied to the input area may be detected by the electrical characteristics of the pressure sensor disposed at a position adjacent to the input area.

The touch input device 1000 shown in FIG. 8 has been described above by way of example. Also, in the touch input device 1000 shown in FIGS. 5a to 5h, 6a to 6e, and FIGS. 7a to 7j, it is also possible to detect the pressure applied to the non-display area 120 in the same manner. Specifically, in the touch input device 1000 shown in FIGS. 6a to 6b and 7a to 7c, when the pressure is applied to the cover layer 100, the cover layer 100 and the display panel 200A may be bent. Here, due to the bending of the cover layer 100 and the display panel 200A, a distance between the pressure sensor 450 disposed under the display panel 200A and a reference potential layer disposed under the pressure sensor 450 may change and the capacitance detected by the pressure sensor 450 may change according to a distance between the pressure sensor 450 and the reference potential layer. Here, the reference potential layer may be the substrate 300. Therefore, the magnitude of the applied pressure may be detected by the capacitance detected by the pressure sensor 450. Also, in the touch input device 1000 shown in FIGS. 6c to 6e and 7d to 7i, when the pressure is applied to the cover layer 100, the cover layer 100 and the display panel 200A may be bent. Here, due to the bending of the cover layer 100 and the display panel 200A, a distance between the pressure sensor 450 disposed on the substrate 300 side and the reference potential layer disposed on the pressure sensor 450 may change and the capacitance detected by the pressure sensor 450 may change according to the distance between the pressure sensor 450 and the reference potential layer. Here, the reference potential layer may be the bottom surface of the display panel 200A, a potential layer located in the display panel 200A, or the SUS can 350. Therefore, the magnitude of the applied pressure may be detected by the capacitance detected by the pressure sensor 450. Here, as shown in FIGS. 6e, 7h, and 7i, when the groove spacer layer 425 is disposed under the pressure sensor 450, a portion of the substrate 300, which is disposed under the pressure sensor 450 and the groove spacer layer 425 may be the reference potential layer. Here, the thickness of the groove spacer layer 425 may be less than that of the spacer layer 420. Therefore, the sensitivity in the case where the pressure is detected by the thickness change of the groove spacer layer 425 may be higher than the sensitivity in the case where the pressure is detected by the spacer layer 420.

As shown in FIG. 9b, when the pressure is applied to the display area 110, the magnitude of the pressure applied to the display area 110 may be detected by the electrical characteristics of the pressure sensor disposed under the display panel 200A.

Here, when the touch sensor 10 disposed under the display area 110 determines whether or not the pressure is applied to the input area disposed within the non-display area 120, the case where the pressure is applied to the input area disposed within the non-display area 120 may not be clearly distinguished from the case where the pressure is applied to the display area 110. Specifically, when the pressure is applied to the display area 110 by a non-conductor, the touch position is not detected by the touch sensor 10 disposed under the display area 110. Therefore, this case may not be distinguished from the case where the pressure is applied to the input area disposed within the non-display area 120.

As shown in FIG. 9a, when the pressure is applied to the input area disposed within the non-display area 120 of the touch input device 1000 according to the embodiment of the present invention, the cover layer 100 corresponding to the position where the pressure is applied may be the most bent, and the cover layer 100 and the display panel 200A which correspond to the display area 110 at a position adjacent to the position where the pressure is applied may be relatively less bent.

As shown in FIG. 9b, when the pressure is applied to the display area 110 of the touch input device 1000 according to the embodiment of the present invention, the cover layer 100 and the display panel 200A which correspond to the position where the pressure is applied may be the most bent, and the cover layer 100 and the display panel 200A which correspond to the display area 110 at a position adjacent to the position where the pressure is applied may be relatively less bent.

Specifically, the case where the pressure is applied to the home key 121 included in the non-display area 120 is compared with the case where the pressure is applied to a position where the pressure sensor “A” which is included in the display area 110 and is adjacent to the home key 121. As shown in FIGS. 10a and 10b, the change amount of the electrical characteristics detected from the pressure sensor “A” in the case where the pressure is applied to the position where the pressure sensor “A” is disposed is greater than the change amount of the electrical characteristics detected from the pressure sensor “A” in the case where the pressure is applied to the home key 121, and the number of other pressure sensors “B” adjacent to the pressure sensor “A” having the changing electrical characteristics in the case where the pressure is applied to the position where the pressure sensor “A” is disposed is greater than the number of other pressure sensors “B” adjacent to the pressure sensor “A” having the changing electrical characteristics in the case where the pressure is applied to the home key 121. In other words, the profile of the electrical characteristics detected from the pressure sensor 450 when the pressure is applied to the display area 110 may be different from the profile of the electrical characteristics detected from the pressure sensor 450 when the pressure is applied to the input area disposed within the non-display area 120. Therefore, on the basis of the profile of the electrical characteristics detected from the pressure sensor 450, the determination of whether the pressure is applied to input area disposed within the non-display area 120 can be made.

The case where the input area is disposed within the non-display area 120 has been described as shown in FIG. 9b in the foregoing. However, as shown in FIGS. 4d, 4e, 5d, 5e, 9c, and the like, likewise, even when the input area is disposed within the display area 110, the determination of whether the pressure is applied to input area disposed within the display area 110 can be made on the basis of the profile of the electrical characteristics detected from the pressure sensor 450.

As such, it is determined that the pressure is applied to the input area by using the separate touch sensor 550 or without using the separate touch sensor 550. When the magnitude of the pressure applied to the input area is greater than a predetermined value, a function corresponding to the input area may be performed. Also, when the separate touch sensor is the user authentication sensor, if the user is authenticated by the user authentication sensor and the magnitude of the pressure applied to the input area is greater than a predetermined value, a function corresponding to the input area may be performed. For example, when the magnitude of the pressure applied to the home key 121 is greater than a predetermined value, an initial screen may be displayed on the display area 110. Also, when the magnitude of the pressure applied to the speaker 122 is greater than a predetermined value, a volume control setting screen may be displayed. When the magnitude of the pressure applied to the camera 123 is greater than a predetermined value, a photographing application may be performed. Likewise, when the magnitude of the pressure applied to the backspace key is greater than a predetermined value, a backward function may be performed. When the magnitude of the pressure applied to the menu key is greater than a predetermined value, a menu bar may be performed. The above functions corresponding to the input area can be performed even when the touch input device 1000 is in a standby mode.

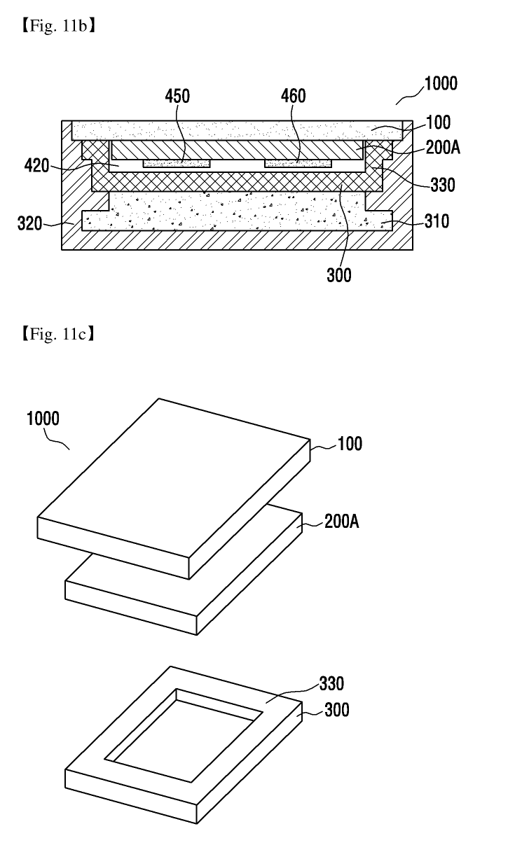

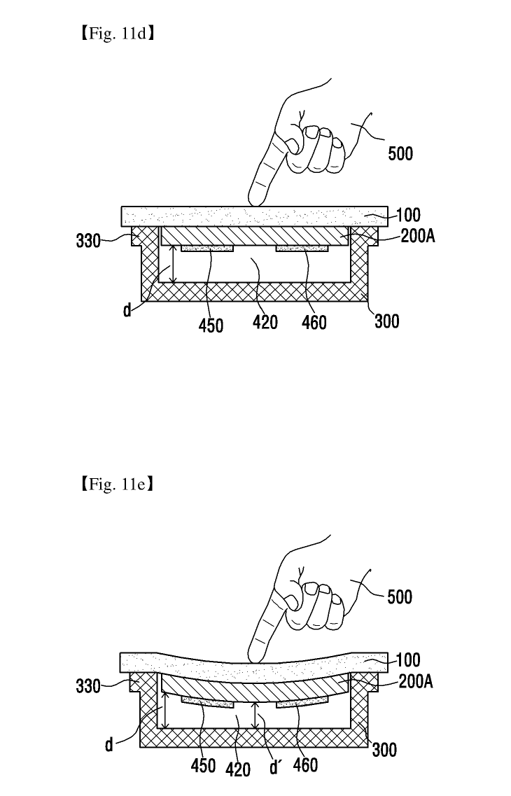

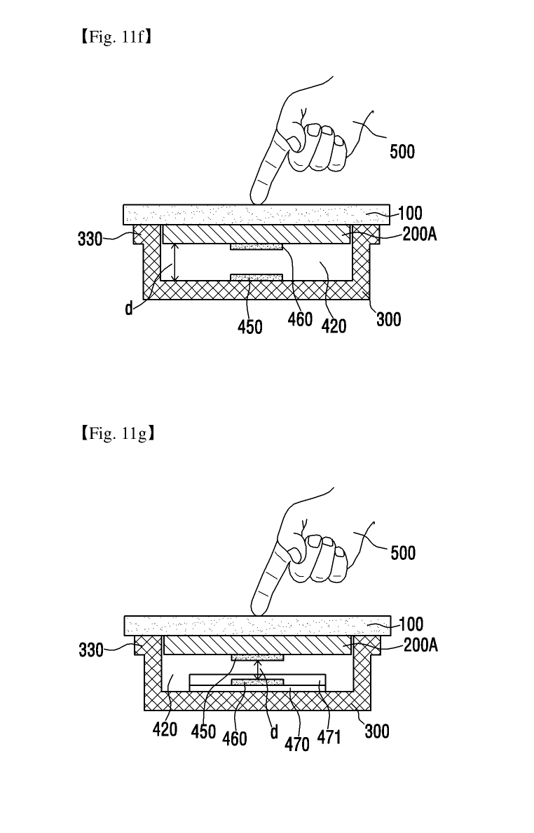

FIGS. 11a, 11b, and 11d to 11g are cross sectional views taken along line A-A′ of the touch input device according to the embodiment of the present invention shown in FIG. 4a. FIG. 11c is an exploded perspective view of the touch input device according to the embodiment of the present invention.

In FIG. 11a and some of the following figures, it is shown that the display panel 200A is directly laminated on and attached to the cover layer 100. However, this is only for convenience of description. The display module 200 where the first polarization layers 271 and 282 is located on the display panel 200A may be laminated on and attached to the cover layer 100. When the LCD panel is the display panel 200A, the second polarization layer 272 and the backlight unit are omitted.

In the description with reference to FIGS. 11a to 11g, it is shown that as the touch input device 1000 according to the embodiment of the present invention, the cover layer 100 in which the touch sensor has been formed is laminated on and attached to the display module 200 shown in FIGS. 3a and 3b by means of an adhesive. However, the touch input device 1000 according to the embodiment of the present invention may include that the touch sensor 10 is disposed inside the display module 200 shown in FIGS. 3a and 3b. More specifically, while FIGS. 11a to 11c show that the cover layer 100 where the touch sensor 10 has been formed covers the display module 200 including the display panel 200A, the touch input device 1000 which includes the touch sensor 10 disposed inside the display module 200 and includes the display module 200 covered with the cover layer 100 like glass may be used as the embodiment of the present invention.

The touch input device 1000 according to the embodiment of the present invention may include an electronic device including the touch screen, for example, a cell phone, a personal data assistant (PDA), a smart phone, a tablet personal computer, an MP3 player, a laptop computer, etc.

In the touch input device 1000 according to the embodiment of the present invention, a substrate 300, together with an outermost housing 320 of the touch input device 1000, may function to surround a mounting space 310, etc., where the circuit board and/or battery for operation of the touch input device 1000 are placed. Here, the circuit board for operation of the touch input device 1000 may be a main board. A central processing unit (CPU), an application processor (AP) or the like may be mounted on the circuit board. Due to the substrate 300, the display module 200 is separated from the circuit board and/or battery for operation of the touch input device 1000. Due to the substrate 300, electrical noise generated from the display module 200 and noise generated from the circuit board can be blocked.

The touch sensor 10 or the cover layer 100 of the touch input device 1000 may be formed wider than the display module 200, the substrate 300, and the mounting space 310. As a result, the housing 320 may be formed such that the housing 320, together with the touch sensor 10, surrounds the display module 200, the substrate 300, and the circuit board.

The touch input device 1000 according to the embodiment of the present invention may detect the touch position through the touch sensor 10 and may detect the touch pressure by placing a separate sensor and using it as the pressure sensing unit, which is different from the electrode used to detect the touch position and the electrode used to drive the display. Here, the touch sensor 10 may be disposed inside or outside the display module 200.

Hereafter, the components for detecting the pressure are collectively referred to as the pressure sensing unit. For example, the pressure sensing unit of the embodiment shown in FIG. 11a may include a sensor sheet 440, and the pressure sensing unit of the embodiment shown in FIG. 11b may include pressure sensors 450 and 460.

In the touch input device according to the embodiment of the present invention, as shown in FIG. 11a, the sensor sheet 440 including the pressure sensors 450 and 460 may be disposed between the display module 200 and the substrate 300, or alternatively, as shown in FIG. 11b, the pressure sensors 450 and 460 may be directly formed on the bottom surface of the display panel 200A.

Also, the pressure sensing unit is formed to include, for example, the spacer layer 420 composed of an air gap. This will be described in detail with reference to FIGS. 11a to 11g.

According to the embodiment, the spacer layer 420 may be implemented by the air gap. According to the embodiment, the spacer layer 420 may be made of an impact absorbing material. According to the embodiment, the spacer layer 420 may be filled with a dielectric material. According to the embodiment, the spacer layer 420 may be made of a material having a restoring force by which the material contracts by applying the pressure and returns to its original shape by releasing the pressure. According to the embodiment, the spacer layer 420 may be made of elastic foam. Also, since the spacer layer is disposed under the display module 200, the spacer layer may be made of a transparent material or an opaque material.

Also, a reference potential layer may be disposed under the display module 200. Specifically, the reference potential layer may be formed on the substrate 300 disposed under the display module 200. Alternatively, the substrate 300 itself may serve as the reference potential layer. Also, the reference potential layer may be disposed on the cover (not shown) which is disposed on the substrate 300 and under the display module 200 and functions to protect the display module 200. Alternatively, the cover itself may serve as the reference potential layer. When a pressure is applied to the touch input device 1000, the display panel 200A is bent. Due to the bending of the display panel 200A, a distance between the reference potential layer and the pressure sensor 450 and 460 may be changed. Also, the spacer layer may be disposed between the reference potential layer and the pressure sensor 450 and 460. Specifically, the spacer layer may be disposed between the display module 200 and the substrate 300 where the reference potential layer has been disposed or between the display module 200 and the cover where the reference potential layer has been disposed.

Also, the reference potential layer may be disposed inside the display module 200. Specifically, the reference potential layer may be disposed on the top surfaces or bottom surfaces of the first substrate layers 261 and 281 of the display panel 200A or on the top surfaces or bottom surfaces of the second substrate layers 262 and 283. When a pressure is applied to the touch input device 1000, the display panel 200A is bent. Due to the bending of the display panel 200A, the distance between the reference potential layer and the pressure sensor 450 and 460 may be changed. Also, the spacer layer may be disposed between the reference potential layer and the pressure sensor 450 and 460. In the case of the touch input device 1000 shown in FIGS. 3a and 3b, the spacer layer may be disposed on or within the display panel 200A.

Likewise, according to the embodiment, the spacer layer may be implemented by the air gap. According to the embodiment, the spacer layer may be made of the impact absorbing material. According to the embodiment, the spacer layer may be filled with a dielectric material. According to the embodiment, the spacer layer may be made of a material having a restoring force by which the material contracts by applying the pressure and returns to its original shape by releasing the pressure. According to the embodiment, the spacer layer may be made of elastic foam. Also, since the spacer layer is disposed on or within the display panel 200A, the spacer layer may be made of a transparent material.

According to the embodiment, when the spacer layer is disposed inside the display module 200, the spacer layer may be the air gap which is included during the manufacture of the display panel 200A and/or the backlight unit. When the display panel 200A and/or the backlight unit includes one air gap, the one air gap may function as the spacer layer. When the display panel 200A and/or the backlight unit includes a plurality of the air gaps, the plurality of air gaps may collectively function as the spacer layer.

FIG. 11c is a perspective view of the touch input device 1000 according to the embodiment shown in FIG. 11a. As shown in FIG. 11c, the sensor sheet 440 of the embodiment may be disposed between the display module 200 and the substrate 300 in the touch input device 1000. Here, the touch input device 1000 may include the spacer layer disposed between the display module 200 and the substrate 300 in order to dispose the sensor sheet 440.

Hereafter, for the purpose of clearly distinguishing the electrodes 450 and 460 from the electrode included in the touch sensor 10, the sensors 450 and 460 for detecting the pressure are designated as pressure sensors 450 and 460. Here, since the pressure sensors 450 and 460 are disposed in the rear side instead of in the front side of the display panel 200A, the pressure sensor 450 and 460 may be made of an opaque material as well as a transparent material. When the display panel 200A is the LCD panel, the light from the backlight unit must transmit through the pressure sensors 450 and 460. Therefore, the pressure sensors 450 and 460 may be made of a transparent material such as ITO.

Here, a frame 330 having a predetermined height may be formed along the border of the upper portion of the substrate 300 in order to maintain the spacer layer 420 in which the pressure sensor 450 and 460 are disposed. Here, the frame 330 may be bonded to the cover layer 100 by means of an adhesive tape (not shown). While FIG. 11c shows the frame 330 is formed on the entire border (e.g., four sides of the quadrangle) of the substrate 300, the frame 330 may be formed only on at least some (e.g., three sides of the quadrangle) of the border of the substrate 300. According to the embodiment, the frame 330 may be formed on the top surface of the substrate 300 may be integrally formed with the substrate 300 on the top surface of the substrate 300. In the embodiment of the present invention, the frame 330 may be made of an inelastic material. In the embodiment of the present invention, when a pressure is applied to the display panel 200A through the cover layer 100, the display panel 200A, together with the cover layer 100, may be bent. Therefore, the magnitude of the touch pressure can be detected even though the frame 330 is not deformed by the pressure.

FIG. 11d is a cross sectional view of the touch input device including the pressure sensor according to the embodiment of the present invention. As shown in FIG. 11d, the pressure sensors 450 and 460 according to the embodiment of the present invention may be formed within the spacer layer 420 and on the bottom surface of the display panel 200A.

The pressure sensor for detecting the pressure may include the first sensor 450 and the second sensor 460. Here, any one of the first sensor 450 and the second sensor 460 may be a drive sensor, and the other may be a receiving sensor. A drive signal is applied to the drive sensor, and a sensing signal including information on electrical characteristics changing by applying the pressure may be obtained through the receiving sensor. For example, when a voltage is applied, a mutual capacitance may be generated between the first sensor 450 and the second sensor 460.

FIG. 11e is a cross sectional view when a pressure is applied to the touch input device 1000 shown in FIG. 11d. The top surface of the substrate 300 may have a ground potential so as to block the noise. When a pressure is applied to the surface of the cover layer 100 by an object 500, the cover layer 100 and the display panel 200A may be bent or pressed. As a result, a distance “d” between the ground potential surface and the pressure sensors 450 and 460 may be decreased to “d′”. In this case, due to the decrease of the distance “d”, the fringing capacitance is absorbed in the top surface of the substrate 300, so that the mutual capacitance between the first sensor 450 and the second sensor 460 may be reduced. Therefore, the magnitude of the touch pressure can be calculated by obtaining the reduction amount of the mutual capacitance from the sensing signal obtained through the receiving sensor.

Although it has been described in FIG. 11e that the top surface of the substrate 300 has the ground potential, that is to say, is the reference potential layer, the reference potential layer may be disposed inside the display module 200. Here, when a pressure is applied to the surface of the cover layer 100 by the object 500, the cover layer 100 and the display panel 200A may be bent or pressed. As a result, a distance between the pressure sensors 450 and 460 and the reference potential layer disposed inside the display module 200 is changed. Therefore, the magnitude of the touch pressure can be calculated by obtaining the capacitance change amount from the sensing signal obtained through the receiving sensor.

In the touch input device 1000 according to the embodiment of the present invention, the display panel 200A may be bent or pressed by the touch applying the pressure. When the display panel 200A is bent or pressed according to the embodiment, a position showing the biggest deformation may not match the touch position. However, the display panel 200A may be shown to be bent at least at the touch position. For example, when the touch position approaches close to the border, edge, etc., of the display panel 200A, the most bent or pressed position of the display panel 200A may not match the touch position, however, the display panel 200A may be shown to be bent or pressed at least at the touch position.

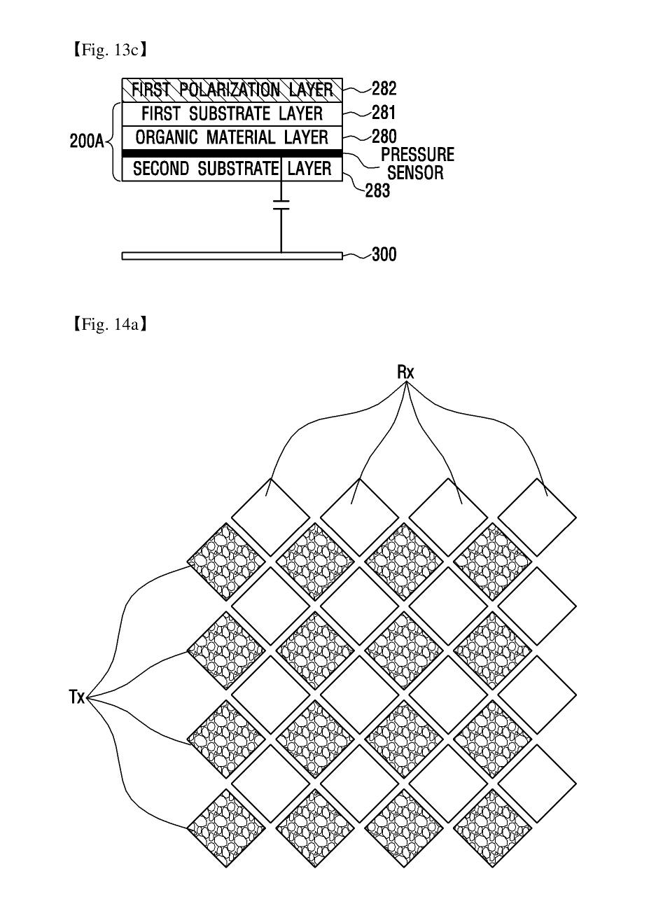

In the state where the first sensor 450 and the second sensor 460 are formed in the same layer, each of the first sensor 450 and the second sensor 460 shown in FIGS. 11d and 11e may be, as shown in FIG. 14a, composed of a plurality of lozenge-shaped sensors. Here, the plurality of the first sensors 450 are connected to each other in the first axial direction, and the plurality of the second sensors 460 are connected to each other in the second axial direction orthogonal to the first axial direction. The lozenge-shaped sensors of at least one of the first sensor 450 and the second sensor 460 are connected to each other through a bridge, so that the first sensor 450 and the second sensor 460 may be insulated from each other. Also, here, the first sensor 450 and the second sensor 460 shown in FIG. 13 may be composed of a sensor having a form shown in FIG. 14b.

In the foregoing, it is shown that the touch pressure is detected from the change of the mutual capacitance between the first sensor 450 and the second sensor 460. However, the pressure sensing unit may be configured to include only any one of the first sensor 450 and the second sensor 460. In this case, it is possible to detect the magnitude of the touch pressure by detecting the change of the capacitance between the one pressure sensor and a ground layer (the reference potential layer disposed inside the display module 200 or the substrate 300), that is to say, the change of the self-capacitance. Here, the drive signal is applied to the one pressure sensor, and the change of the self-capacitance between the pressure sensor and the ground layer can be detected by the pressure sensor.

For instance, in FIG. 11d, the pressure sensor may be configured to include only the first sensor 450. Here, the magnitude of the touch pressure can be detected by the change of the capacitance between the first sensor 450 and the substrate 300, which is caused by a distance change between the substrate 300 and the first sensor 450. Since the distance “d” is reduced with the increase of the touch pressure, the capacitance between the substrate 300 and the first sensor 450 may be increased with the increase of the touch pressure. Here, the pressure sensor should not necessary have a comb teeth shape or a trident shape, which is required to improve the detection accuracy of the mutual capacitance change amount. The pressure sensor may have a plate shape (e.g., quadrangular plate). Or, as shown in FIG. 14d, the plurality of the first sensors 450 may be disposed at a regular interval in the form of a grid.

FIG. 11f shows that the pressure sensors 450 and 460 are formed within the spacer layer 420 and on the top surface of the substrate 300 and on the bottom surface of the display module 200. Here, when the pressure sensing unit is, as shown in FIG. 11a, comprised of the sensor sheet, the sensor sheet is composed of a first sensor sheet 440-1 including the first sensor 450 and a second sensor sheet 440-2 including the second sensor 460. Here, one of the first sensor 450 and the second sensor 460 may be formed on the substrate 300 and the other may be formed on the bottom surface of the display module 200. FIG. 11g shows that the first sensor 450 is formed on the substrate 300 and the second sensor 460 is formed on the bottom surface of the display module 200.

FIG. 11g shows that the pressure sensors 450 and 460 are formed within the spacer layer 420 and on the top surface of the substrate 300 and on the bottom surface of the display panel 200A. Here, the first sensor 450 may be formed on the bottom surface of the display panel 200A, and the second sensor 460 may be disposed on the top surface of the substrate 300 in the form of a sensor sheet in which the second sensor 460 is formed on a first insulation layer 470 and a second insulation layer 471 is formed on the second sensor 460.

When the object 500 applies a pressure to the surface of the cover layer 100, the cover layer 100 and the display panel 200A may be bent or pressed. As a result, a distance “d” between the first sensor 450 and the second sensor 460 may be reduced. In this case, the mutual capacitance between the first sensor 450 and the second sensor 460 may be increased with the reduction of the distance “d”. Therefore, the magnitude of the touch pressure can be calculated by obtaining the increase amount of the mutual capacitance from the sensing signal obtained through the receiving sensor. Here, in FIG. 11g, since the first sensor 450 and the second sensor 460 are formed in different layers, the first sensor 450 and the second sensor 460 should not necessary have a comb teeth shape or a trident shape. Any one sensor of the first sensor 450 and the second sensor 460 may have a plate shape (e.g., quadrangular plate), and the other remaining plural sensors may be, as shown in FIG. 14d, disposed at a regular interval in the form of a grid.

While the foregoing has described that the pressure sensors 450 and 460 are, as shown in FIG. 11b, directly formed on the bottom surface of the display panel 200A, the embodiment in which the sensor sheet 440 including the pressure sensors 450 and 460 is, as shown in FIG. 11a, disposed between the display module 200 and the substrate 300 can be also applied. Specifically, the sensor sheet 440 including the pressure sensors 450 and 460 may be attached to the bottom surface of the display module 200 or may be attached to the top surface of the substrate 300.

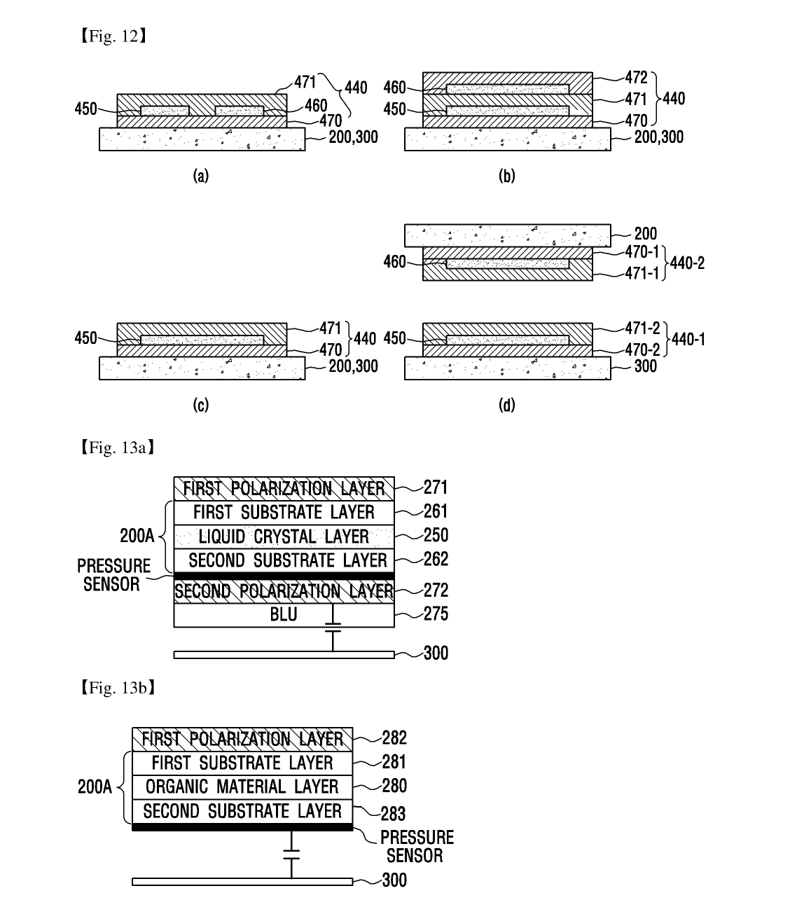

In this case, the top surface of the substrate 300 may have the ground potential for shielding the noise. FIG. 12 shows a cross section of the sensor sheet according to the embodiment of the present invention. Referring to (a) of FIG. 12, the cross sectional view shows that the sensor sheet 440 including the pressure sensors 450 and 460 has been attached to the substrate 300 or the display module 200. Here, a short-circuit can be prevented from occurring between the pressure electrodes 450 and 460 and either the substrate 300 or the display module 200 because the pressure sensors 450 and 460 are disposed between the first insulation layer 470 and the second insulation layer 471 in the sensor sheet 440. Depending on the type and/or implementation method of the touch input device 1000, the substrate 300 or the display module 200 to which the pressure sensors 450 and 460 are attached may not have the ground potential or may have a weak ground potential. In this case, the touch input device 1000 according to the embodiment of the present invention may further include a ground electrode (not shown) between the insulation layer 470 and either the substrate 300 or the display module 200. According to the embodiment of the present invention, the touch input device 1000 invention may further include another insulation layer (not shown) between the ground electrode and either the substrate 300 or the display module 200. Here, the ground electrode (not shown) is able to prevent the size of the capacitance generated between the first sensor 450 and the second sensor 460, which are pressure sensors, from increasing excessively.

It is possible to consider that the first sensor 450 and the second sensor 460 are formed in different layers in accordance with the embodiment of the present invention so that a sensor layer is formed. In (b) of FIG. 12, the cross sectional view shows that the first sensor 450 and the second sensor 460 are formed in different layers. As shown in (b) of FIG. 12, the first sensor 450 may be formed on the first insulation layer 470, and the second sensor 460 may be formed on the second insulation layer 471 located on the first sensor 450. According to the embodiment of the present invention, the second sensor 460 may be covered with a third insulation layer 472. In other words, the sensor sheet 440 may include the first to third insulation layers 470 to 472, the first sensor 450, and the second sensor 460. Here, the first sensor 450 and the second sensor 460 may be implemented so as to overlap each other because they are disposed in different layers. For example, the first sensor 450 and the second sensor 460 may be, as shown in FIG. 14c, formed similarly to the pattern of the drive electrode TX and receiving electrode RX which are arranged in the form of M×N array. Here, M and N may be natural numbers greater than 1. Also, as shown in FIG. 14a, the lozenge-shaped first sensor 450 and the lozenge-shaped second sensor 460 may be located in different layers respectively.

In (c) of FIG. 12, the cross sectional view shows that the sensor sheet 440 is implemented to include only the first sensor 450. As shown in (c) of FIG. 12, the sensor sheet 440 including the first sensor 450 may be disposed on the substrate 300 or the display module 200.

In (d) of FIG. 12, the cross sectional view shows that the first sensor sheet 440-1 including the first sensor 450 is attached to the substrate 300, and the second sensor sheet 440-2 including the second sensor 460 is attached to the display module 200. As shown in (d) of FIG. 12, the first sensor sheet 440-1 including the first sensor 450 may be disposed on the substrate 300. Also, the second sensor sheet 440-2 including the second sensor 460 may be disposed on the bottom surface of the display module 200.

As with the description related to (a) of FIG. 12, when the substrate 300 or the display module 200 to which the pressure sensors 450 and 460 are attached may not have the ground potential or may have a weak ground potential, the sensor sheet 440 in (a) to (d) of FIG. 12 may further include a ground electrode (not shown) between the first insulation layers 470, 470-1, and 470-2 and either the substrate 300 or the display module 200. Here, the sensor sheet 440 may further include an additional insulation layer (not shown) between the ground electrode (not shown) and either the substrate 300 or the display module 200.

In the touch input device 1000 according to the embodiment of the present invention, the pressure sensors 450 and 460 may be directly formed on the display panel 200A. FIGS. 13a to 13c are cross sectional views showing an embodiment of the pressure sensor formed directly on various display panel of the touch input device according to the embodiment of the present invention.

First, FIG. 13a shows the pressure sensors 450 and 460 formed on the display panel 200A using the LCD panel. Specifically, as shown in FIG. 13a, the pressure sensors 450 and 460 may be formed on the bottom surface of the second substrate layer 262. Here, the pressure sensors 450 and 460 may be formed on the bottom surface of the second polarization layer 272. In detecting the touch pressure on the basis of the mutual capacitance change amount when a pressure is applied to the touch input device 1000, a drive signal is applied to the drive sensor 450, and an electrical signal including information on the capacitance which is changed by the distance change between the pressure sensors 450 and 460 and the reference potential layer separated from the pressure sensors 450 and 460 is received from the receiving sensor 460. When the touch pressure is detected on the basis of the self-capacitance change amount, a drive signal is applied to the pressure sensors 450 and 460, and an electrical signal including information on the capacitance which is changed by the distance change between the pressure sensors 450 and 460 and the reference potential layer separated from the pressure sensors 450 and 460 is received from the pressure sensors 450 and 460. Here, the reference potential layer may be the substrate 300 or may be the cover which is disposed between the display panel 200A and the substrate 300 and performs a function of protecting the display panel 200A.

Next, FIG. 13b shows the pressure sensors 450 and 460 formed on the bottom surface of the display panel 200A using the OLED panel (in particular, AM-OLED panel). Specifically, the pressure sensors 450 and 460 may be formed on the bottom surface of the second substrate layer 283. Here, a method for detecting the pressure is the same as that described in FIG. 13a.

In the case of the OLED panel, since the organic material layer 280 emits light, the pressure sensors 450 and 460 which are formed on the bottom surface of the second substrate layer 283 disposed under the organic material layer 280 may be made of an opaque material. However, in this case, a pattern of the pressure sensors 450 and 460 formed on the bottom surface of the display panel 200A may be shown to the user. Therefore, for the purpose of directly forming the pressure sensors 450 and 460 on the bottom surface of the second substrate layer 283, a light shielding layer like black ink is applied on the bottom surface of the second substrate layer 283, and then the pressure sensors 450 and 460 may be formed on the light shielding layer.

Also, FIG. 13b shows that the pressure sensors 450 and 460 are formed on the bottom surface of the second substrate layer 283. However, a third substrate layer (not shown) may be disposed under the second substrate layer 283, and the pressure sensors 450 and 460 may be formed on the bottom surface of the third substrate layer. In particular, when the display panel 200A is a flexible OLED panel, the third substrate layer which is not relatively easily bent may be disposed under the second substrate layer 283 because the display panel 200A composed of the first substrate layer 281, the organic material layer 280, and the second substrate layer 283 is very thin and easily bent.

Next, FIG. 13c shows the pressure sensors 450 and 460 formed inside the display panel 200A using the OLED panel. Specifically, the pressure sensors 450 and 460 may be formed on the top surface of the second substrate layer 283. Here, a method for detecting the pressure is the same as that described in FIG. 13a.

Also, although the display panel 200A using the OLED panel has been described by taking an example thereof with reference to FIG. 13c, it is possible that the pressure sensors 450 and 460 are formed on the top surface of the second substrate layer 262 of the display panel 200A using the LCD panel.

Also, although it has been described in FIGS. 13a to 13c that the pressure sensors 450 and 460 are formed on the top surfaces or bottom surfaces of the second substrate layers 262 and 283, it is possible that the pressure sensors 450 and 460 are formed on the top surfaces or bottom surfaces of the first substrate layers 261 and 281.

Also, it has been described in FIGS. 13a to 13c that the pressure sensing unit including the pressure sensors 450 and 460 is directly formed on the display panel 200A. However, the pressure sensing unit may be directly formed on the substrate 300, and the potential layer may be the display panel 200A or may be the cover which is disposed between the display panel 200A and the substrate 300 and performs a function of protecting the display panel 200A.

Also, although it has been described in FIGS. 13a to 13c that the reference potential layer is disposed under the pressure sensing unit, the reference potential layer may be disposed within the display panel 200A. Specifically, the reference potential layer may be disposed on the top surface or bottom surface of the first substrate layers 261 and 281 of the display panel 200A or may be disposed on the top surface or bottom surface of the second substrate layers 262 and 283.

In the touch input device 1000 according to the embodiment of the present invention, the pressure sensors 450 and 460 for sensing the capacitance change amount may be, as described in FIG. 11g, composed of the first sensor 450 which is directly formed on the display panel 200A and the second sensor 460 which is configured in the form of a sensor sheet. Specifically, the first sensor 450 may be, as described in FIGS. 13a to 13c, directly formed on the display panel 200A, and second sensor 460 may be, as described in FIG. 11g, configured in the form of a sensor sheet and may be attached to the touch input device 1000.

In the touch input device 1000 according to the embodiment of the present invention, when the pressure sensor controller 1300 and the touch sensor controller 1100 are integrated into one IC and driven, a controller of the IC may perform the scanning of the touch sensor 10 and simultaneously perform the scanning of the pressure sensing unit, or the controller of the IC may perform the time-sharing, and then may generate a control signal such that the scanning of the touch sensor 10 is performed in a first time interval and the scanning of the pressure sensing unit is performed in a second time interval different from the first time interval.

In the foregoing, it has been described that the pressure sensors 450 and 460 included in the pressure sensing unit are composed of the electrodes and as the electrical characteristic sensed by the pressure sensing unit, the capacitance change amount due to the bending of the display panel 200A is detected, so that the magnitude of the pressure is detected. However, there is no limitation to this. The pressure sensor 450 included in the pressure sensing unit are composed of the strain gauge and as the electrical characteristic sensed by the pressure sensing unit, the change amount of a resistance value of the pressure sensor 450 which is changed by the bending of the display panel 200A is detected, so that the magnitude of the pressure is detected.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A touch input device comprising:
a cover layer comprising a display area and an input area;
a display panel which is disposed under the display area; and
a pressure sensing unit which is disposed under the display panel and is disposed at a position adjacent to the input area,
wherein the pressure sensing unit comprises a pressure sensor,
wherein, when a pressure is applied to the cover layer, the cover layer and the display panel are bent,
wherein electrical characteristics of the pressure sensor change due to the bending of the cover layer and the display panel, and
wherein, when the pressure is applied to the input area, a magnitude of the pressure applied to the input area is detected by the electrical characteristics of the pressure sensor.

2. The touch input device of claim 1, wherein the cover layer further comprises a non-display area, and wherein the input area is disposed within the non-display area.

3. The touch input device of claim 2, further comprising a touch sensor which is disposed under the display area, wherein, when a touch position is not detected by the touch sensor and the detected magnitude of the pressure applied to the input area is greater than a predetermined value, a function corresponding to the input area is performed.

4. The touch input device of claim 2, further comprising a touch sensor which is disposed under the input area, wherein, when a touch position is detected by the touch sensor and the detected magnitude of the pressure applied to the input area is greater than a predetermined value, a function corresponding to the input area is performed.

5. The touch input device of claim 4, wherein the touch sensor is integrally formed with the pressure sensing unit.

6. The touch input device of claim 2, further comprising a user authentication sensor which is disposed under the input area, wherein, when a user is authenticated by the user authentication sensor and the detected magnitude of the pressure applied to the input area is greater than a predetermined value, a function corresponding to the input area is performed.

7. The touch input device of claim 1, wherein the input area is disposed within the display area.

8. The touch input device of claim 7, further comprising a touch sensor which is disposed under the input area, wherein, when a touch position is detected by the touch sensor and the detected magnitude of the pressure applied to the input area is greater than a predetermined value, a function corresponding to the input area is performed.

9. The touch input device of claim 7, further comprising a user authentication sensor which is disposed under the input area, wherein, when a user is authenticated by the user authentication sensor and the detected magnitude of the pressure applied to the input area is greater than a predetermined value, a function corresponding to the input area is performed.

10. A touch input device comprising:
a cover layer comprising a display area and an input area;
a display panel which is disposed under the display area; and
a pressure sensing unit which is disposed under the display panel,
wherein the pressure sensing unit comprises a plurality of pressure sensors,
wherein, when a pressure is applied to the cover layer, the cover layer and the display panel are bent,
wherein electrical characteristics of the plurality of pressure sensors change due to the bending of the cover layer and the display panel,
wherein, when the pressure is applied to the display area, a magnitude of the pressure applied to the display area is detected by the electrical characteristics of the plurality of pressure sensors, and
wherein, when the pressure is applied to the input area, a magnitude of the pressure applied to the input area is detected by the electrical characteristics of the pressure sensor out of the plurality of pressure sensors, which is disposed at a position adjacent to the input area.

11. The touch input device of claim 10, wherein the cover layer further comprises a non-display area, and wherein the input area is disposed within the non-display area.

12. The touch input device of claim 11, further comprising a touch sensor which is disposed under the display area, wherein, when a touch position is not detected by the touch sensor and the detected magnitude of the pressure applied to the input area is greater than a predetermined value, a function corresponding to the input area is performed.

13. The touch input device of claim 11, further comprising a touch sensor which is disposed under the input area, wherein, when a touch position is detected by the touch sensor and the detected magnitude of the pressure applied to the input area is greater than a predetermined value, a function corresponding to the input area is performed.

14. The touch input device of claim 13, wherein the touch sensor is integrally formed with the pressure sensing unit.

15. The touch input device of claim 11, further comprising a user authentication sensor which is disposed under the input area, wherein, when a user is authenticated by the user authentication sensor and the detected magnitude of the pressure applied to the input area is greater than a predetermined value, a function corresponding to the input area is performed.

16. The touch input device of claim 10, wherein the input area is disposed within the display area.

17. The touch input device of claim 16, further comprising a touch sensor which is disposed under the input area, wherein, when a touch position is detected by the touch sensor and the detected magnitude of the pressure applied to the input area is greater than a predetermined value, a function corresponding to the input area is performed.

18. The touch input device of claim 16, further comprising a user authentication sensor which is disposed under the input area, wherein, when a user is authenticated by the user authentication sensor and the detected magnitude of the pressure applied to the input area is greater than a predetermined value, a function corresponding to the input area is performed.

19. The touch input device of claim 10, wherein, on the basis of a profile of the electrical characteristics of the plurality of pressure sensors, a determination of whether the pressure applied to the cover layer is applied to the input area.
